(19) United States
(12) Patent Application Publication
(10) Pub. No.: US 2026/0118545 A1
(43) Pub. Date: Apr. 30, 2026

(54) MULTI-TUBULAR CEMENT BOND EVALUATION WITH ELECTROMAGNETIC AND ACOUSTIC JOINT PROCESSING

(71) Applicant: Halliburton Energy Services, Inc., Houston, TX (US)

(72) Inventors: Xiang Wu, Houston, TX (US); Christopher Michael Jones, Houston, TX (US); Ahmed Fouda, Houston, TX (US)

(73) Assignee: Halliburton Energy Services, Inc., Houston, TX (US)

(21) Appl. No.: 18/932,417

(22) Filed: Oct. 30, 2024

(51) Int. Cl. G01V 11/00; E21B 47/005

(52) U.S. Cl. CPC G01V 11/002; E21B 47/005

(57) ABSTRACT

A method and system for evaluating a cement bond. The method may include disposing a logging tool in a wellbore. The logging tool may include an electromagnetic (EM) sub and an acoustic sub. The method may further comprise transmitting an EM field from the EM sub into one or more tubulars to energize the one or more tubulars with the EM field and measuring a secondary EM field in the one or more tubulars with a EM receive. The method may further comprise transmitting a shaped acoustic signal from the acoustic sub into one or more tubulars and formation, measuring a result signal with the acoustic sub to form one or more acoustic measurements, estimating one or more pipe parameters from the eddy current, and evaluating a cement bond based at least in part on the one or more pipe parameters and the one or more acoustic measurements.

### BACKGROUND

For oil and gas exploration and production, a network of wells, installations and other conduits may be established by connecting sections of metal pipe together. For example, a well installation may be completed, in part, by lowering multiple sections of metal pipe (e.g., a casing string) into a wellbore, and cementing the casing string in place. In some well installations, multiple casing strings are employed (e.g., a concentric multi-string arrangement) to allow for different operations related to well completion, production, or enhanced oil recovery (EOR) options.

At the end of a well installations' life, the well installation may be plugged and abandoned. Understanding cement bond integrity to a conduit string may be beneficial in determining how to plug the well installation. Generally, acoustics may be implemented by acoustic tools to form CBLs (cement bond log). However, the tubing is usually not centered in the casing, due to the curvature of the tubing or well inclination. The eccentricity may affect the signal, thus, a method working for a centric case may not work for eccentric cases.

### BRIEF DESCRIPTION OF THE DRAWINGS

These drawings illustrate certain aspects of some examples of the present disclosure and should not be used to limit or define the disclosure.

FIG. 1 illustrates an example of a logging tool disposed in a wellbore;

FIG. 2 illustrates an example of arbitrary defects within multiple pipes;

FIG. 3A illustrates an example of an electromagnetic (EM) sub traversing a wellbore;

FIG. 3B illustrates another example of the EM sub traversing a wellbore;

FIG. 3C illustrates another example of the EM sub traversing a wellbore;

FIG. 3D illustrates another example of the EM sub tool traversing a wellbore;

FIG. 3E illustrates another example of the EM sub tool traversing a wellbore;

FIG. 4 illustrates an example of a well plan;

FIG. 5 illustrates a schematic of an information handling system;

FIG. 6 illustrates a schematic of a chip set;

FIG. 7 illustrates a computing network;

FIG. 8 illustrates a neural network;

FIG. 9 illustrates a workflow for determining cement bonding based at least in part on estimated pipe parameters and/or acoustic measurements;

FIG. 10A illustrates a perspective of the EM sub disposed within a pipe string;

FIG. 10B illustrates a cross-section diagram view the EM sub disposed within the pipe string;

FIGS. 11-15 are different orientations of a EM transmitter and EM receiver in the EM sub;

FIG. 16 illustrates a model-based inversion algorithm;

FIG. 17 illustrates an example of an acoustic transmitter and an acoustic receiver;

FIG. 18 illustrates the acoustic sub broadcasting a shaped signal;

FIG. 19 illustrates graph of a time domain signal from a single receiver for two cement bonding conditions;

FIG. 20 illustrates a dispersion curve;

FIG. 21 illustrates a time domain dipole signal;

FIG. 22 illustrates a workflow that determines a bonding condition between material and casing using both EM and acoustic measurements;

FIG. 23 illustrates another embodiment of a workflow that determines a bonding condition between material and casing using both EM and acoustic measurements; and

FIGS. 24A & 24B illustrate a workflow for performing acoustic measurements utilizing a pitch-catch method of measurements.

### DETAILED DESCRIPTION

This disclosure may generally relate to pipe inspection in subterranean wells and, more particularly, to methods and systems for cement evaluation for plug and abandonment operation. At the end of a well's life, cement integrity needs to be evaluated to ensure the well may be properly plugged. Traditional cement bond log (CBL) tool requires the production tubing to be pulled out so that the signal may directly reach casing through borehole fluid. The disclosed method enables the operator to evaluate cement integrity without pulling out the tubing, which can result in significant cost-saving.

Moreover, the tubing is usually not centered in the casing, due to the curvature of the tubing or well inclination. The eccentricity may affect the signal, thus, a method working for a centric case may not work for eccentric cases. The disclosed method and systems below may be designed to overcome the effect of eccentricity. In this disclosure, eccentricity is used to describe the displacement of both tubing and tool away from the casing center. The tubing and the tool are assumed to be concentric with a centralizer in place. In order to produce a CBL for eccentric cases, both electromagnetic logging and acoustic logging may be implemented.

Electromagnetic (EM) sensing may provide continuous in-situ measurements of parameters related to the integrity of pipes in cased boreholes. As a result, EM sensing may be used in cased borehole monitoring applications. EM logging tools may be configured for multiple concentric pipes (e.g., for one or more) with the first pipe diameter varying (e.g., from about two inches to about seven inches or more).

EM logging tools may measure eddy currents to determine metal loss, location of collars, and use magnetic cores with one or more coils to detect defects in multiple concentric pipes. The EM logging tools may use pulse eddy current (time-domain) and may employ multiple (long, short, and transversal) coils to evaluate multiple types of defects in multiple concentric pipes. It should be noted that the techniques utilized in time-domain may be utilized in frequency-domain measurements. In examples, EM logging tools may operate on a conveyance. Additionally, EM logging tools may comprise an independent power supply and may store the acquired data on memory.

Monitoring the condition of the production and intermediate casing strings is crucial in oil and gas field operations. EM eddy current (EC) techniques have been successfully used in inspection of these components. EM EC techniques comprise two broad categories: frequency-domain EC techniques and time-domain EC techniques. In both techniques, one or more transmitters are excited with an excitation signal to form an electromagnetic field, which may be referred to as an electromagnetic signal. The electromagnetic field may energies pipes that may be disposed around the transmitters, which may form an eddy current. The eddy current may then form secondary electromagnetic fields that may be referred to as secondary signals. The secondary signals from the pipes may be received and recorded for interpretation. The magnitude of a received signal is generally inversely proportional to the amount of metal that is present in the inspection location. For example, less signal magnitude is typically an indication of more metal, and more signal magnitude is an indication of less metal or more metal. Measurements taken with EM logging tools may be utilized with measurements from an acoustic logging sub to form a cement bond log.

Acoustic sensing may incorporate resonance wave(s) and non-resonance wave(s) and provide continuous in situ measurements of parameters related to cement bonding to a casing. As a result, acoustic sensing may be used in cased borehole monitoring applications. As disclosed herein, acoustic logging subs may be used to emit an acoustic signal which may traverse through at least part of a conduit string to at least part of a casing. Reflected signals that are measured by the acoustic logging sub may be defined as result signals. Result signals may be analyzed to determine if the section of casing is fully bonded, is free pipe, or if a partially bonded section. The return signal may comprise the resonance mode signal as well as other signals such as reflection, guided waves, tool mode, and/or Stoneley wave. Using both an EM logging tool and acoustic logging tool, a cement bond log may be formed no matter the structure of the tubing within a wellbore.

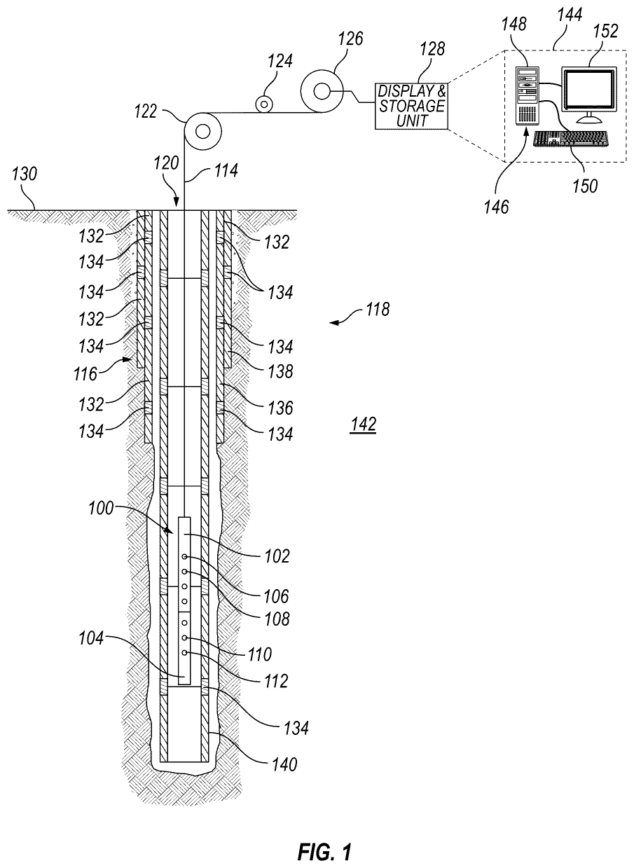

FIG. 1 illustrates an operating environment for a logging tool 100 as disclosed herein in accordance with some embodiments. As illustrated, logging tool 100 may comprise an EM logging sub 102 and an acoustic logging sub 104. Logging tool 100 may comprise an EM transmitter 106 and/or an EM receiver 108. In examples, EM transmitters 106 and EM receivers 108 may be a coil, an antenna, or a Hall effect sensor. Furthermore, EM transmitter 106 and EM receiver 108 may be separated by a space between about 0.1 inches (0.254 cm) to about 200 inches (508 cm). In examples, EM logging sub 102 may be an induction tool, in which EM transmitters 106 may operate with a continuous wave current for the transmission of EM fields at one or more frequencies. In other examples, EM transmitters 106 may operate with a pulsed current for the transmission of EM fields at one or more frequencies. Additionally, EM receivers 108 may measure an amplitude and a phase or a real and an imaginary part of a voltage of the one or more frequencies from an EM field or secondary EM field. Additionally, EM receivers 108 may measure a decay response of a voltage at one or more time delays from an EM field or secondary EM field. This may be performed with any number of EM transmitters 106 and/or any number of EM receivers 108, which may be disposed on EM logging sub 102. In additional examples, of EM transmitters 106 may function and/or operate as an EM receiver 108 or vice versa. EM transmitters 106 and/or EM receivers 108 are discussed in greater detail below. During measurement operations, EM logging sub 102 may take one or more measurements in conjunction with measurements form acoustic logging sub 104.

Acoustic logging sub 104 may comprise an acoustic transmitter 110 and/or an acoustic receiver 112. In examples, acoustic transmitters 110 and acoustic receivers 112 may be unipole, monopole, dipole, quadrupole, or hydrophones. It should be noted, that a monopole is an omnidirectional acoustic source and a unipole is a single directional source. In other examples, acoustic receiver 112 may be a sectorial of one or more receivers 112 or a ring of one or more receivers 112. Additionally, one or more acoustic receivers 112 may be disposed on a rotary section of acoustic logging sub 104, which may allow for one or more acoustic receivers 112 to rotate relative to acoustic logging sub 104. Furthermore, acoustic transmitter 110 and acoustic receiver 112 may be separated by a space between about 0.1 inches (0.254 cm) to about 200 inches (508 cm). In examples, acoustic logging sub may operate and function with any number of acoustic transmitters 110 and/or any number of acoustic receivers 112, which may be disposed on acoustic logging sub 104. In additional examples, acoustic transmitters 110 may function and/or operate as an acoustic receiver 112 or vice versa. Acoustic transmitters 110 and/or acoustic receivers 112 are discussed in greater detail below. Acoustic logging sub 104 is illustrated as being adjacent to EM logging sub 102. However, in examples, acoustic logging sub 104 and EM logging sub 102 may be spaced apart with one or more subs disposed between them to form logging tool 100.

Logging tool 100 may be operatively coupled to a conveyance 114 (e.g., wireline, slickline, coiled tubing, pipe, downhole tractor, and/or the like) which may provide mechanical suspension, as well as electrical connectivity, for logging tool 100. Conveyance 114 and logging tool 100 may extend within casing string 116 to a desired depth within the wellbore 118. Conveyance 114, which may comprise one or more electrical conductors, may exit wellhead 120, may pass around pulley 122, may engage odometer 124, and may be reeled onto winch 126, which may be employed to raise and lower the tool assembly in wellbore 118.

Signals, both electromagnetic and/or acoustic, may be recorded by EM logging sub 102 and/or acoustic logging sub 104. The signals may be stored on memory and then processed by display and storage unit 128 after recovery of logging tool 100 from wellbore 118. Alternatively, signals recorded by EM logging sub 102 and/or acoustic logging sub 104 may be conducted to display and storage unit 128 by way of conveyance 114. Display and storage unit 128 may process the signals, and the information contained therein may be displayed for an operator to observe and stored for future processing and reference. It should be noted that an operator may comprise an individual, group of individuals, or organization, such as a service company. Alternatively, signals may be processed downhole prior to receipt by display and storage unit 128 or both downhole and at surface 130, for example, by display and storage unit 128. Display and storage unit 128 may also contain an apparatus for supplying control signals and power to logging tool 100 in casing string 116.

A typical casing string 116 may extend from wellhead 120 at or above ground level to a selected depth within a wellbore 118. Casing string 116 may comprise a plurality of joints 132 or segments of casing string 116, each joint 132 being connected to the adjacent segments by a collar 134. There may be any number of layers in casing string 116. Such as, a first casing 136 and a second casing 138. It should be noted that there may be any number of casing layers.

FIG. 1 also illustrates a typical pipe string 140, which may be positioned inside of casing string 116 extending part of the distance down wellbore 118. Pipe string 140 may be production tubing, tubing string, casing string, or other pipe disposed within casing string 116. Pipe string 140 may comprise concentric pipes. It should be noted that concentric pipes may be connected by joints 132. Logging tool 100 may be dimensioned so that it may be lowered into the wellbore 118 through pipe string 140, thus avoiding the difficulty and expense associated with pulling pipe string 140 out of wellbore 118.

Logging tool 100 may comprise a digital telemetry system which may further comprise one or more electrical circuits, not illustrated, to supply power to logging tool 100 and to transfer data between display and storage unit 128 and logging tool 100. A DC voltage may be provided to logging tool 100 by a power supply located above ground level, and data may be coupled to the DC power conductor by a baseband current pulse system. Alternatively, logging tool 100 may be powered by batteries located within logging tool 100 and data provided by logging tool 100 may be stored within logging tool 100, rather than transmitted to the surface to display and storage unit 128 during logging operations. The data may comprise signals and measurements related to corrosion detection.

During operations, EM transmitter 106 may broadcast and/or transmit electromagnetic fields into subterranean formation 142. It should be noted that broadcasting electromagnetic fields may also be referred to as transmitting electromagnetic fields. The electromagnetic fields transmitted from EM transmitter 106 may be referred to as a primary electromagnetic field. The primary electromagnetic fields may produce Eddy currents in casing string 116 and pipe string 140. These Eddy currents, in turn, produce secondary electromagnetic fields that may be sensed and/or measured by EM receivers 108. Characterization of casing string 116 and pipe string 140, comprising determination of pipe attributes, may be performed by measuring and processing primary and secondary electromagnetic fields. Pipe attributes may comprise, but are not limited to, pipe thickness, pipe conductivity, and/or pipe permeability.

As illustrated, EM receivers 108 may be positioned on EM logging sub 102 at selected distances (e.g., axial spacing) away from EM transmitters 106. The axial spacing of EM receivers 108 from EM transmitter 106 may vary, for example, from about 0 inches (0 cm) to about 40 inches (101.6 cm) or more. It should be understood that the configuration of logging tool 100 shown on FIG. 1 is merely illustrative and other configurations of logging tool 100 may be used with the present techniques. A spacing of 0 inches (0 cm) may be achieved by collocating coils with different diameters. While FIG. 1 shows only a single array of EM receivers 108, there may be multiple sensor arrays where the distance between EM transmitter 106 and EM receivers 108 in each of the sensor arrays may vary. Arrays of EM transmitters 106 and/or arrays of EM receivers 108 may be disposed axially or azimuthally along EM logging sub 102. In addition, EM logging sub 102 may comprise one or more EM transmitter 106 and more or less than six EM receivers 108. In addition, EM transmitter 106 may be a coil implemented for transmission of magnetic field while also measuring EM fields, in some instances. Where multiple EM transmitters 106 are used, their operation may be multiplexed or time multiplexed. For example, a single EM transmitter 106 may broadcast, for example, a multi-frequency signal or a broadband signal. While not shown, EM logging sub 102 may comprise an EM transmitter 106 and EM receiver 108 that are in the form of coils or solenoids coaxially positioned within a downhole tubular (e.g., casing string 116) and separated along the tool axis. Alternatively, EM logging sub 102 may comprise an EM transmitter 106 and EM receiver 108 that are in the form of coils or solenoids coaxially positioned within a downhole tubular (e.g., casing string 116) and collocated along the axis of Logging tool 100.

Broadcasting of EM fields by EM transmitter 106 and the sensing and/or measuring of secondary electromagnetic fields by EM receivers 108 may be controlled by display and storage unit 128, which may comprise an information handling system 144. As illustrated, the information handling system 144 may be a component of or be referred to as the display and storage unit 128, or vice-versa. Alternatively, the information handling system 144 may be a component of logging tool 100. An information handling system 144 may comprise any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price.

Information handling system 144 may comprise a processing unit 146 (e.g., microprocessor, central processing unit, etc.) that may process EM log data by executing software or instructions obtained from a local non-transitory computer readable media 148 (e.g., optical disks, magnetic disks). The non-transitory computer readable media 148 may store software or instructions of the methods described herein. Non-transitory computer readable media 148 may comprise any instrumentality or aggregation of instrumentalities that may retain data and/or instructions for a period of time. Non-transitory computer readable media 148 may comprise, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also comprise input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with EM logging tool 100 and/or software executed by processing unit 146. For example, information handling system 144 may enable an operator to select analysis options, view collected log data, view analysis results, and/or perform other tasks.

EM logging sub 102 may use any suitable EM technique based on Eddy current (“EC”) for inspection of concentric pipes (e.g., casing string 116 and pipe string 140). EC techniques may be particularly suited for characterization of a multi-string arrangement in which concentric pipes are used. EC techniques may comprise, but are not limited to, frequency-domain EC techniques and time-domain EC techniques.

In frequency domain EC techniques, EM transmitter 106 of EM logging sub 102 may be fed by a continuous sinusoidal signal, producing primary magnetic fields that illuminate the concentric pipes (e.g., casing string 116 and pipe string 140). The primary electromagnetic fields produce Eddy currents in the concentric pipes. These Eddy currents, in turn, produce secondary electromagnetic fields that may be sensed and/or measured with the primary electromagnetic fields by EM receivers 108. Characterization of the concentric pipes may be performed by measuring and processing these electromagnetic fields.

In time domain EC techniques, which may also be referred to as pulsed EC (“PEC”), EM transmitter 106 may be fed by a pulse. Transient primary electromagnetic fields may be produced due to the transition of the pulse from “off” to “on” state or from “on” to “off” state (more common). These transient electromagnetic fields produce EC in the concentric pipes (e.g., casing string 116 and pipe string 140). The EC, in turn, produces secondary electromagnetic fields that may be sensed and/or measured by EM receivers 108 placed at some distance on EM logging sub 102 from EM transmitter 106, as shown on FIG. 1. Alternatively, the secondary electromagnetic fields may be sensed and/or measured by a co-located receiver (not shown) or with EM transmitter 106 itself.

It should be understood that while casing string 116 is illustrated as a single casing string, there may be multiple layers of concentric pipes disposed in the section of wellbore 118 with casing string 116. EM log data may be obtained in two or more sections of wellbore 118 with multiple layers of concentric pipes. For example, EM logging sub 102 may make a first measurement of pipe string 140 comprising any suitable number of joints 132 connected by joints 132. Measurements may be taken in the time-domain and/or frequency range. EM logging sub 102 may make a second measurement in a casing string 116 of first casing 136, wherein first casing 136 comprises any suitable number of pipes connected by joints 132. Measurements may be taken in the time-domain and/or frequency domain. These measurements may be repeated any number of times for first casing 136, for second casing 138, and/or any additional layers of casing string 116. In this disclosure, as discussed further below, methods may be utilized to determine the location of any number of joints 132 in casing string 116 and/or pipe string 140. Determining the location of joints 132 in the frequency domain and/or time domain may allow for accurate processing of recorded data in determining properties of casing string 116 and/or pipe string 140 such as corrosion. As mentioned above, measurements may be taken in the frequency domain and/or the time domain.

In frequency domain EC, the frequency of the excitation may be adjusted so that multiple reflections in the wall of the pipe (e.g., casing string 116 or pipe string 140) are insignificant, and the spacing between EM transmitters 106 and/or EM receiver 108 is large enough that the contribution to the mutual impedance from the dominant (but evanescent) waveguide mode is small compared to the contribution to the mutual impedance from the branch cut component. In examples, a remote-field eddy current (RFEC) effect may be observed. In an RFEC regime, the mutual impedance between the coil of EM transmitter 106 and coil of one of EM receivers 108 may be sensitive to the thickness of the pipe wall. To be more specific, the phase of the impedance varies as:

$$φ = 2 \sqrt{\frac{ω μ σ}{2}} t \qquad ( 1 )$$

and the magnitude of the impedance shows the dependence:

$$exp [ - 2 ( \sqrt{\frac{ω μ σ}{2}} ) t ] \qquad ( 2 )$$

where ω is the angular frequency of the excitation source, μ is the magnetic permeability of the pipe, σ is the electrical conductivity of the pipe, and t is the thickness of the pipe. By using the common definition of skin depth for the metals as:

$$δ = \sqrt{\frac{2}{ω μ σ}} \qquad ( 3 )$$

The phase of the impedance varies as:

$$φ ≅ 2 \frac{t}{δ} \qquad ( 4 )$$

and the magnitude of the impedance shows the dependence:

$$exp [ \frac{- 2 t}{δ} ] \qquad ( 5 )$$

In RFEC, the estimated quantity may be the overall thickness of the metal. Thus, for multiple concentric pipes, the estimated parameter may be the overall or sum of the thickness of the pipes. The quasi-linear variation of the phase of mutual impedance with the overall metal thickness may be employed to perform fast estimation to estimate the overall thickness of multiple concentric pipes. For this purpose, for any given set of pipes dimensions, material properties, and tool configuration, such linear variation may be constructed quickly and may be used to estimate the overall thickness of concentric pipes. Information handling system 144 may enable an operator to select analysis options, view collected log data, view analysis results, and/or perform other tasks.

Monitoring the condition of pipe string 140 and casing string 116 may be performed on information handling system 144 in oil and gas field operations. Information handling system 144 may be utilized with Electromagnetic (EM) Eddy Current (EC) techniques to inspect pipe string 140 and casing string 116. EM EC techniques may comprise frequency-domain EC techniques and time-domain EC techniques. In time-domain and frequency-domain techniques, one or more EM transmitters 106 may be excited with an excitation signal which broadcast an electromagnetic field and EM receiver 108 may sense and/or measure the reflected excitation signal, a secondary electromagnetic field, for interpretation. The received signal is proportional to the amount of metal that is around EM transmitter 106 and EM receiver 108. For example, less signal magnitude is typically an indication of more metal, and more signal magnitude is an indication of less metal. This relationship may be utilized to determine metal loss, which may be due to an abnormality related to the pipe such as corrosion or buckling.

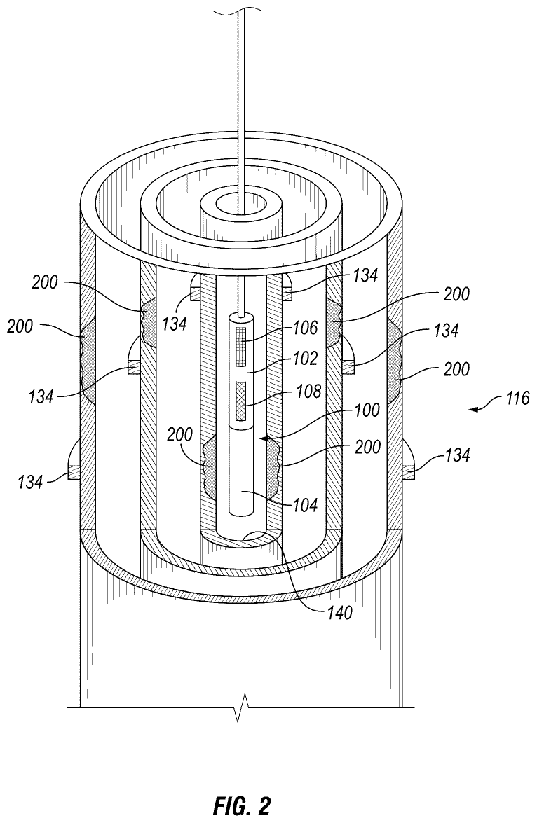

FIG. 2 shows EM logging sub 102 disposed in pipe string 140 which may be surrounded by a plurality of nested pipes (e.g., first casing 136 and second casing 138) and an illustration of anomalies 200 disposed within the plurality of nested pipes, in accordance with some embodiments. As EM logging sub 102 moves across pipe string 140 and casing string 116, one or more EM transmitters 106 may be excited, and a signal (mutual impedance between EM transmitter 106 transmitter and EM receiver 108) at one or more EM receivers 108, may be recorded.

Due to eddy current physics and electromagnetic attenuation, pipe string 140 and/or casing string 116 may generate an electrical signal that is in the opposite polarity to the incident signal and results in a reduction in the received signal. Typically, more metal volume translates to more lost signal. As a result, by inspecting the signal gains, it is possible to identify zones with metal loss (such as corrosion). In order to distinguish signals that originate from anomalies at different pipes of a multiple nested pipe configuration, multiple transmitter-receiver spacing, and frequencies may be utilized. For example, short-spaced EM transmitters 106 and EM receivers 108 may be sensitive to first casing 136, while longer spaced EM transmitters 106 and EM receivers 108 may be sensitive to second casing 138 and/or deeper (3rd, 4th, etc.) pipes. By analyzing the signal levels at these different channels with inversion methods, it is possible to relate a certain received signal to a certain metal loss or gain at each pipe. In addition to loss of metal, other pipe properties such as magnetic permeability and conductivity may also be estimated by inversion methods. It should be noted that inversion methods may comprise model-based inversion which may comprise forward modeling. However, there may be factors that complicate interpretation of losses. For example, deep pipe signals may be significantly lower than other signals. Double dip indications appear for long spaced EM transmitters 106 and EM receivers 108. Spatial spread of long spaced transmitter-receiver signals for a collar 134 may be long (up to 6 feet (1.8 meters)). Due to these complications, methods may need to be used to accurately inspect pipe features.

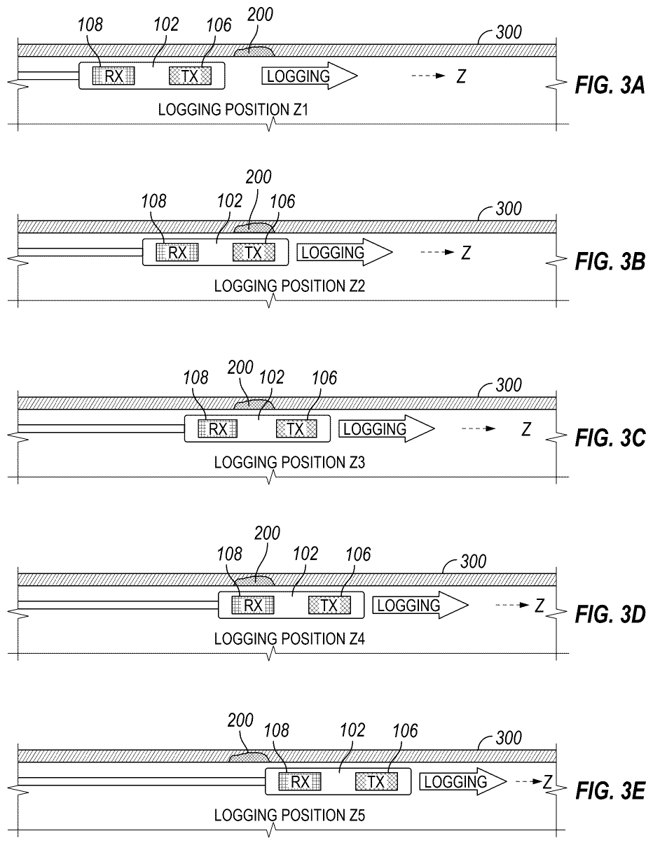

FIGS. 3A-3E illustrate an electromagnetic inspection and detection of anomalies 200 (e.g., defects) or joints 132 (e.g., Referring to FIG. 2), in accordance with some embodiments. As illustrated, EM logging sub 102 may be disposed in pipe string 140, by a conveyance, which may comprise any number of concentric pipes. As EM logging sub 102 traverses across pipe 300, one or more EM transmitters 106 may be excited, and a signal (mutual impedance between EM transmitter 106 and EM receiver 108) at one or more EM receivers 108, may be recorded. Due to eddy currents and electromagnetic attenuation, pipe 300 may generate an electrical signal that is in the opposite polarity to the incident signal and results in a reduction in a received signal. Thus, more metal volume translates to greater signal lost. As a result, by inspecting the signal gains, it may be possible to identify zones with metal loss (such as corrosion). Similarly, by inspecting the signal loss, it may be possible to identify metal gain such as due to presence of a casing collar 134 (e.g., Referring to FIG. 1) where two pipes meet with a threaded connection. In order to distinguish signals from different pipes in a multiple concentric pipe configuration, multiple transmitter-receiver spacing, and frequencies may be used. For example, short-spaced EM transmitters 106 and EM receivers 108 may be sensitive to pipe string 140, while long spaced EM transmitters 106 and EM receivers 108 may be sensitive to deeper pipes (e.g., first casing 136, second casing 138, etc.). By analyzing the signal levels at these different channels through a process of inversion, it may be possible to relate a certain received signal set to a certain set of metal loss or gain at each pipe. In examples, there may be factors that complicate the interpretation and/or identification of joints 132 and/or anomalies 200 (e.g., defects).

For example, due to eddy current physics and electromagnetic attenuation, pipes disposed in pipe string 140 (e.g., referring to FIG. 1 and FIG. 2) may generate an electrical signal that may be in the opposite polarity to the incident signal and results in a reduction in the received signal. Generally, as metal volume increases the signal loss may increase. As a result, by inspecting the signal gains, it may be possible to identify zones with metal loss (such as corrosion). In order to distinguish signals that originate from anomalies 200 (e.g., defects) at different pipes of a multiple nested pipe configuration, multiple transmitter-receiver spacing, and frequencies may be used. For example, short-spaced EM transmitters 106 and EM receivers 108 may be sensitive to first pipe string 140 (e.g., referring to FIG. 2), while long spaced EM transmitters 106 and EM receivers 108 may be sensitive to deeper (2^{nd}, 3^{rd}, etc.) pipes (e.g., first casing 136 and second casing 138).

Analyzing the signal levels at different channels with an inversion scheme, it may be possible to relate a certain received signal to a certain metal loss or gain at each pipe. In addition to loss of metal, other pipe properties such as magnetic permeability and electrical conductivity may also be estimated by inversion. There may be several factors that complicate interpretation of losses: (1) deep pipe signals may be significantly lower than other signals; (2) double dip indications appear for long spaced EM transmitters 106 and EM receivers 108; (3) spatial spread of long spaced transmitter-receiver signal for a collar 134 may be long (up to 6 feet); (4) to accurately estimate of individual pipe thickness, the material properties of the pipes (such as magnetic permeability and electrical conductivity) may need to be known with fair accuracy; (5) inversion may be a non-unique process, which means that multiple solutions to the same problem may be obtained and a solution which may be most physically reasonable may be chosen. Due to these complications, an advanced algorithm or workflow may be used to accurately inspect pipe features, for example when more than two pipes may be present in pipe string 140.

During logging operations as EM logging sub 102 traverses across pipe 300 (e.g., referring to FIG. 3), an EM log of the received signals may be produced and analyzed. The EM log may be calibrated prior to running inversion to account for the deviations between measurement and simulation (forward model). The deviations may arise from several factors, comprising the nonlinear behavior of the magnetic core, magnetization of pipes, mandrel effect, and inaccurate well plans. Multiplicative coefficients and constant factors may be applied, either together or individually, to the measured EM log for this calibration.

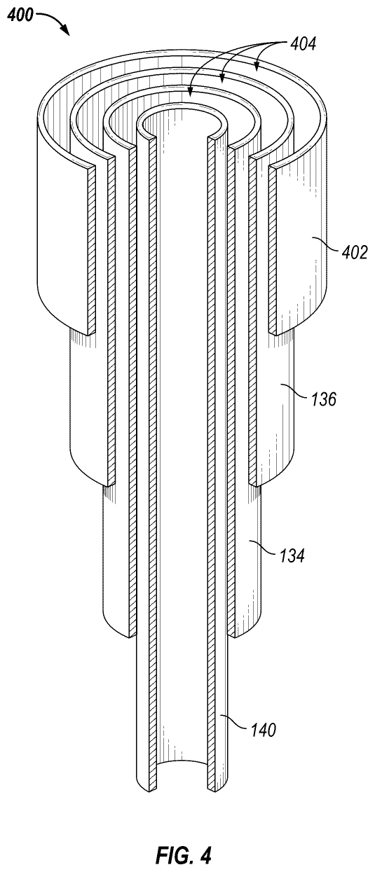

FIG. 4 illustrates an example of a well plan 400 in accordance with some embodiments. Depending on the design of well plan 400, well construction may have between two and four main components. These components comprise conductor, surface, intermediate and production casings. After completion of the well, tubing may be inserted to pump hydrocarbon products. In this example, well plan 400 may comprise pipe string 140, first casing 136, second casing 138, a conductor casing 402, and wherein cement may be disposed in annulus 404 between each casing. However, it should be noted that well plan 400 may comprise any number of pipes, casings, tubulars, and/or the like. Well plan 400 is not limited or bound by the four pipes that are displayed in FIG. 4. When logging tool 100 is used to monitor the pipe condition a log may be produced.

Monitoring the condition of the casing strings is crucial in oil and gas field operations. As discussed above, EM techniques may be used to inspect pipes, casings, tubulars, and/or the like. Measurements taken by EM logging tool 100 may further be processed by information handling system 144 (e.g., referring to FIG. 1).

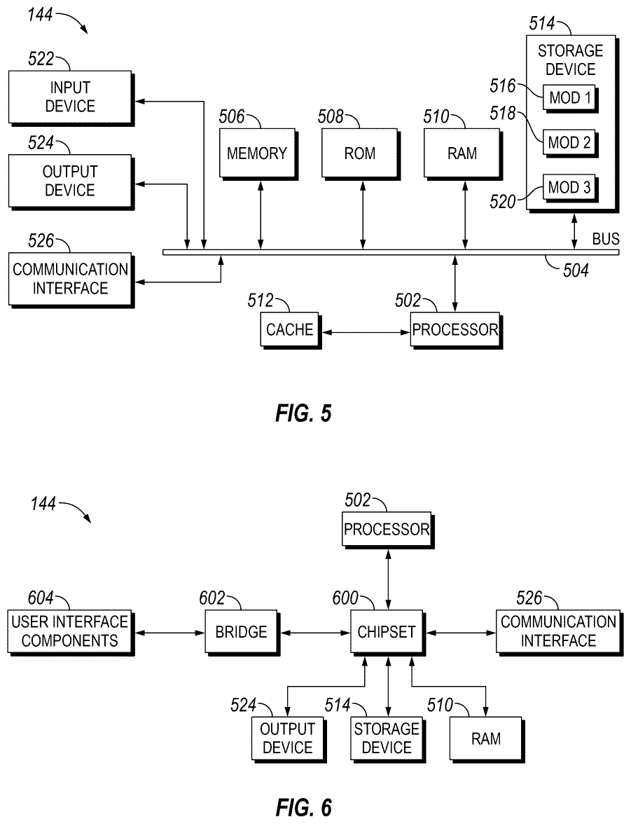

FIG. 5 further illustrates an example information handling system 144 which may be employed to perform various steps, methods, and techniques disclosed herein. Persons of ordinary skill in the art will readily appreciate that other system examples are possible. As illustrated, information handling system 144 comprises a processing unit (CPU or processor) 502 and a system bus 504 that couples various system components comprising system memory 506 such as read only memory (ROM) 508 and random-access memory (RAM) 510 to processor 502. Processors disclosed herein may all be forms of this processor 502. Information handling system 144 may comprise a cache 512 of high-speed memory connected directly with, in close proximity to, or integrated as part of processor 502. Information handling system 144 copies data from memory 506 and/or storage device 514 to cache 512 for quick access by processor 502. In this way, cache 512 provides a performance boost that avoids processor 502 delays while waiting for data. These and other modules may control or be configured to control processor 502 to perform various operations or actions. Other system memory 506 may be available for use as well. Memory 506 may comprise multiple different types of memory with different performance characteristics. It may be appreciated that the disclosure may operate on information handling system 144 with more than one processor 502 or on a group or cluster of computing devices networked together to provide greater processing capability. Processor 502 may comprise any general-purpose processor and a hardware module or software module, such as first module 516, second module 518, and third module 520 stored in storage device 514, configured to control processor 502 as well as a special-purpose processor where software instructions are incorporated into processor 502. Processor 502 may be a self-contained computing system, containing multiple cores or processors, a bus, memory controller, cache, etc. A multi-core processor may be symmetric or asymmetric. Processor 502 may comprise multiple processors, such as a system having multiple, physically separate processors in different sockets, or a system having multiple processor cores on a single physical chip. Similarly, processor 502 may comprise multiple distributed processors located in multiple separate computing devices but working together such as via a communications network. Multiple processors or processor cores may share resources such as memory 506 or cache 512 or may operate using independent resources. Processor 502 may comprise one or more state machines, an application specific integrated circuit (ASIC), or a programmable gate array (PGA) comprising a field PGA (FPGA).

Each individual component discussed above may be coupled to system bus 504, which may connect each and every individual component to each other. System bus 504 may be any of several types of bus structures comprising a memory bus or memory controller, a peripheral bus, and a local bus using any of a variety of bus architectures. A basic input/output (BIOS) stored in ROM 508 or the like, may provide the basic routine that helps to transfer information between elements within information handling system 144, such as during start-up. Information handling system 144 further comprises storage devices 514 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 514 may comprise software modules 516, 518, and 520 for controlling processor 502. Information handling system 144 may comprise other hardware or software modules. Storage device 514 is connected to the system bus 504 by a drive interface. The drives and the associated computer-readable storage devices provide nonvolatile storage of computer-readable instructions, data structures, program modules and other data for information handling system 144. In one aspect, a hardware module that performs a particular function comprises the software component stored in a tangible computer-readable storage device in connection with the necessary hardware components, such as processor 502, system bus 504, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 144 is a small, handheld computing device, a desktop computer, or a computer server. When processor 502 executes instructions to perform “operations”, processor 502 may perform the operations directly and/or facilitate, direct, or cooperate with another device or component to perform the operations.

As illustrated, information handling system 144 employs storage device 514, which may be a hard disk or other types of computer-readable storage devices which may store data that are accessible by a computer, such as magnetic cassettes, flash memory cards, digital versatile disks (DVDs), cartridges, random access memories (RAMs) 510, read only memory (ROM) 508, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 522 represents any number of input mechanisms, such as a microphone for speech, a touch-sensitive screen for gesture or graphical input, keyboard, mouse, motion input, speech and so forth. Additionally, input device 522 may receive one or more EM measurements from EM logging tool 100 (e.g., referring to FIG. 1), discussed above. An output device 524 may also be one or more of a number of output mechanisms known to those of skill in the art. In some instances, multimodal systems enable a user to provide multiple types of input to communicate with information handling system 144. Communications interface 526 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, comprising, but not limited to, hardware capable of executing software and hardware, such as a processor 502, that is purpose-built to operate as an equivalent to software executing on a general purpose processor. For example, the functions of one or more processors presented in FIG. 5 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) 508 for storing software performing the operations described below, and random-access memory (RAM) 510 for storing results. Very large-scale integration (VLSI) hardware embodiments, as well as custom VLSI circuitry in combination with a general-purpose DSP circuit, may also be provided.

FIG. 6 illustrates an example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may comprise a processor 502, representative of any number of physically and/or logically distinct resources capable of executing software, firmware, and hardware configured to perform identified computations. Processor 502 may communicate with a chipset 600 that may control input to and output from processor 502. In this example, chipset 600 outputs information to output device 524, such as a display, and may read and write information to storage device 514, which may comprise, for example, magnetic media, and solid-state media. Chipset 600 may also read data from and write data to RAM 510. A bridge 602 for interfacing with a variety of user interface components 604 may be provided for interfacing with chipset 600. Such user interface components 604 may comprise a keyboard, a microphone, touch detection and processing circuitry, a pointing device, such as a mouse, and so on. In general, inputs to information handling system 144 may come from any of a variety of sources, machine generated and/or human generated.

Chipset 600 may also interface with one or more communication interfaces 526 that may have different physical interfaces. Such communication interfaces may comprise interfaces for wired and wireless local area networks, for broadband wireless networks, as well as personal area networks. Some applications of the methods for generating, displaying, and using the GUI disclosed herein may comprise receiving ordered datasets over the physical interface or be generated by the machine itself by processor 502 analyzing data stored in storage device 514 or RAM 510. Further, information handling system 144 receives inputs from a user via user interface components 604 and executes appropriate functions, such as browsing functions by interpreting these inputs using processor 502.

In examples, information handling system 144 may also comprise tangible and/or non-transitory computer-readable storage devices for carrying or having computer-executable instructions or data structures stored thereon. Such tangible computer-readable storage devices may be any available device that may be accessed by a general purpose or special purpose computer, comprising the functional design of any special purpose processor as described above. By way of example, and not limitation, such tangible computer-readable devices may comprise RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be comprised within the scope of the computer-readable storage devices.

Computer-executable instructions comprise, for example, instructions and data which cause a general-purpose computer, special purpose computer, or special purpose processing device to perform a certain function or group of functions. Computer-executable instructions also comprise program modules that are executed by computers in stand-alone or network environments. Generally, program modules comprise routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, comprising personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

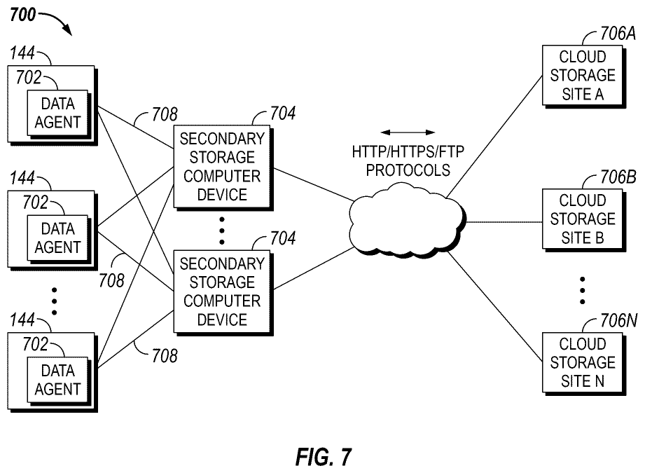

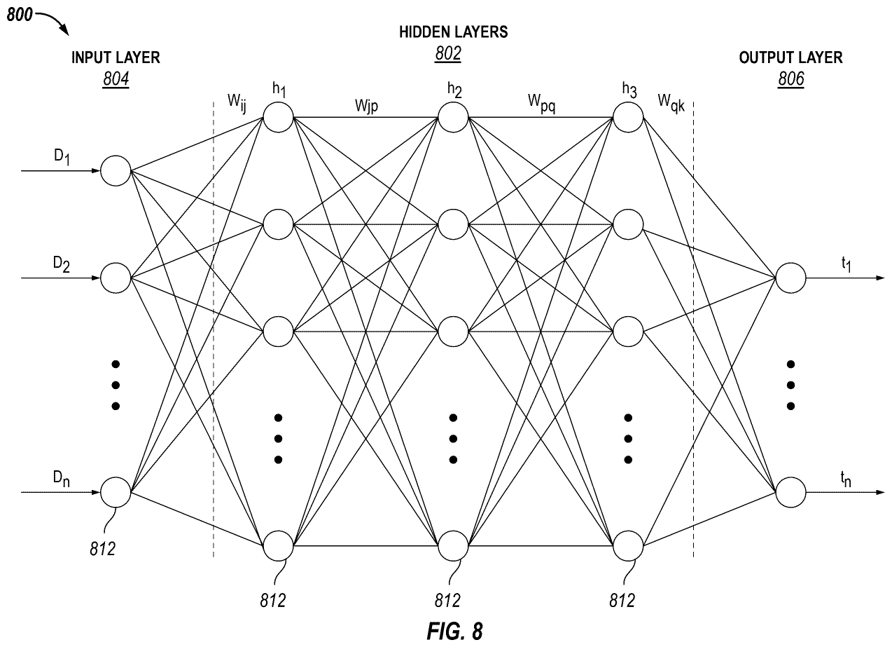

FIG. 7 illustrates an example of one arrangement of resources in a computing network 700 that may employ the processes and techniques described herein, although many others are of course possible. As noted above, an information handling system 144, as part of their function, may utilize data, which comprises files, directories, metadata (e.g., access control list (ACLS) creation/edit dates associated with the data, etc.), and other data objects. The data on the information handling system 144 is typically a primary copy (e.g., a production copy). During a copy, backup, archive or other storage operation, information handling system 144 may send a copy of some data objects (or some components thereof) to a secondary storage computing device 704 by utilizing one or more data agents 702.

A data agent 702 may be a desktop application, website application, or any software-based application that is run on information handling system 144. As illustrated, information handling system 144 may be disposed at any rig site (e.g., referring to FIG. 1), off site location, or repair and manufacturing center. The data agent may communicate with a secondary storage computing device 704 using communication protocol 708 in a wired or wireless system. Communication protocol 708 may function and operate as an input to a website application. In the website application, field data related to pre- and post-operations, generated DTCs, notes, and the like may be uploaded. Additionally, information handling system 144 may utilize communication protocol 708 to access processed measurements, operations with similar DTCs, troubleshooting findings, historical run data, and/or the like. This information is accessed from secondary storage computing device 704 by data agent 702, which is loaded on information handling system 144.

Secondary storage computing device 704 may operate and function to create secondary copies of primary data objects (or some components thereof) in various cloud storage sites 706A-N. Additionally, secondary storage computing device 704 may run determinative algorithms on data uploaded from one or more information handling systems 144, discussed further below. Communications between the secondary storage computing devices 704 and cloud storage sites 706A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 706A-N, the secondary storage computing device 704 may also perform local content indexing and/or local object-level, sub-object-level or block-level deduplication when performing storage operations involving various cloud storage sites 706A-N. Cloud storage sites 706A-N may further record and maintain, EM logs, map DTC codes, store repair and maintenance data, store operational data, and/or provide outputs from determinative algorithms that are located in cloud storage sites 706A-N. In a non-limiting example, this type of network may be utilized as a platform to store, backup, analyze, import, preform extract, transform and load (“ETL”) processes, mathematically process, apply machine learning models, and augment EM measurement data sets.

A machine learning model may be an empirically derived model which may result from a machine learning algorithm identifying one or more underlying relationships within a dataset. In comparison to a physics-based model, such as Maxwell's Equations, which are derived from first principles and define the mathematical relationship of a system, a pure machine learning model may not be derived from first principles. Once a machine learning model is developed, it may be queried in order to predict one or more outcomes for a given set of inputs. The type of input data used to query the model to create the prediction may correlate both in category and type to the dataset from which the model was developed.

The structure of, and the data contained within a dataset provided to a machine learning algorithm may vary depending on the intended function of the resulting machine learning model. The rows of data, or data points, within a dataset may contain one or more independent values. Additionally, datasets may contain corresponding dependent values. The independent values of a dataset may be referred to as “features,” and a collection of features may be referred to as a “feature space.” If dependent values are available in a dataset, they may be referred to as outcomes or “target values.” Although dependent values may be a necessary component of a dataset for certain algorithms, not all algorithms require a dataset with dependent values. Furthermore, both the independent and dependent values of the dataset may comprise either numerical or categorical values.

While it may be true that machine learning model development is more successful with a larger dataset, it may also be the case that the whole dataset isn't used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may comprise evaluating model performance according to whether the model is over-fit or under-fit. As it may be assumed that all datasets contain some level of error, it may be important to evaluate and optimize the model performance and associated model fit by means of model validation. In general, the variability in model fit (e.g.: whether a model is over-fit or under-fit) may be described by the “bias-variance trade-off.” As an example, a model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, comprising, in a non-limiting example, the homogeneity of the dataset, the size of the dataset, the type of algorithm used, and the objective of the model. The ratio of training data to test data may also be determined by the validation method used, wherein some non-limiting examples of validation methods comprise k-fold cross-validation, stratified k-fold cross-validation, bootstrapping, leave-one-out cross-validation, resubstitution, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, comprising the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may comprise the model error, wherein the optimal set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning process. As such, algorithm hyperparameters may affect the computational intensity associated with developing a model from a specific dataset.

Machine learning algorithms, which may be capable of capturing the underlying relationships within a dataset, may be broken into different categories. One such category may comprise whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset comprises both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may comprise Neural Networks, K-Nearest Neighbors, Naïve Bayes, Decision Trees, Classification Trees, Regression Trees, Random Forests, Linear Regression, Support Vector Machines (SVM), Gradient Boosting Regression, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not comprise a dependent variable as the intended function of this type of algorithm is to identify one or more groupings or clusters within a dataset. In a non-limiting example, algorithms which may be utilized for unsupervised machine learning may comprise K-means clustering, K-means classification, Fuzzy C-Means, Gaussian Mixture, Hidden Markov Model, Neural Networks, and Hierarchical algorithms.

In examples to determine a relationship using machine learning, a neural network (NN) 800, as illustrated in FIG. 8, may be utilized to locate collars on one or more pipe strings and/or casings in a well plan 400 (e.g., referring to FIG. 4). A NN 800 is an artificial neural network with one or more hidden layers 802 between input layer 804 and output layer 806. As illustrated, input layer 804 may comprise all extracted electromagnetic responses from logging tool 100 (e.g., referring to FIG. 1), and output layers 806 may comprise pipe information from other sources. During operations, input data is taken by neurons 812 in first layer which then provides an output to the neurons 812 within next layer and so on which provides a final output in output layer 806. Each layer may have one or more neurons 812. The connection between two neurons 812 of successive layers may have an associated weight. The weight defines the influence of the input to the output for the next neuron 812 and eventually for the overall final output. The training process of NN 800 may be utilized to determine cement bonding based at least in part on estimated pipe parameters and/or acoustic measurements.

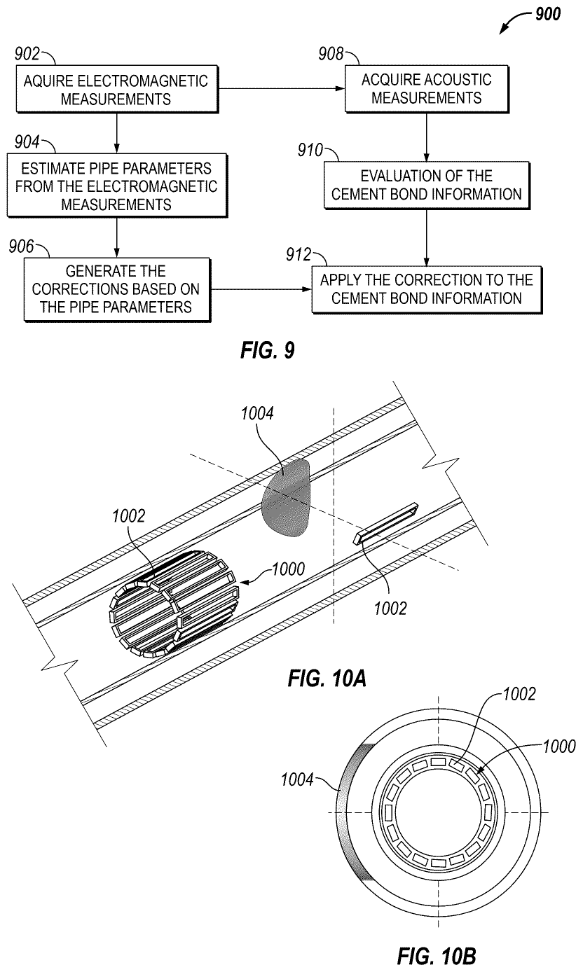

FIG. 9 illustrates workflow 900 for determining cement bonding based at least in part on estimated pipe parameters and/or acoustic measurements. It should be noted that at least a part of workflow 900 may be performed on information handling system 144 (e.g., referring to FIG. 1). Workflow 900 may begin with block 902 or 908. For this disclosure, block 902 is described below first. In block 902, one or more electromagnetic measurements are taken. Electromagnetic measurements are taken as described above. Electromagnetic measurements may be taken by a number of different setups of EM logging sub 102. In examples, it should be noted that electromagnetic measurements may be taken omni-directional or directionally, as selected by personnel.

FIGS. 10A & 10B illustrate a possible configuration of EM transmitter 106 within EM logging sub 102. For example, FIG. 10A illustrates a perspective of EM logging sub 102, disposed within pipe string 140. Within EM logging sub 102, EM transmitter 106 may be disposed azimuthally within EM logging sub 102 for measurement operations. It should be noted that EM transmitter 106 is a coil 1000. FIG. 10B illustrates a cross-section diagram view of EM logging sub 102 disposed within pipe string 140. As seen in FIG. 10B, EM transmitter 106, which is coil 1000, has a number of windings 1002 that form coil 1000. In this setup, coil 1000 may allow for an azimuthal sensing area 1004 disposed on pipe string 140. Orientation of EM transmitter 106 and/or EM receiver 108 may be altered based at least in part on the measurement operation being performed.

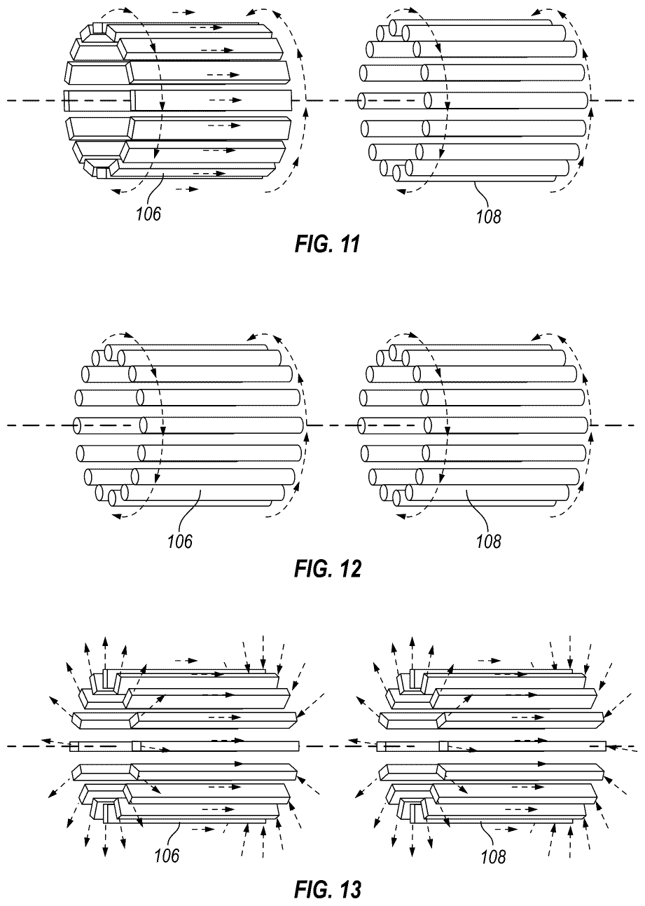

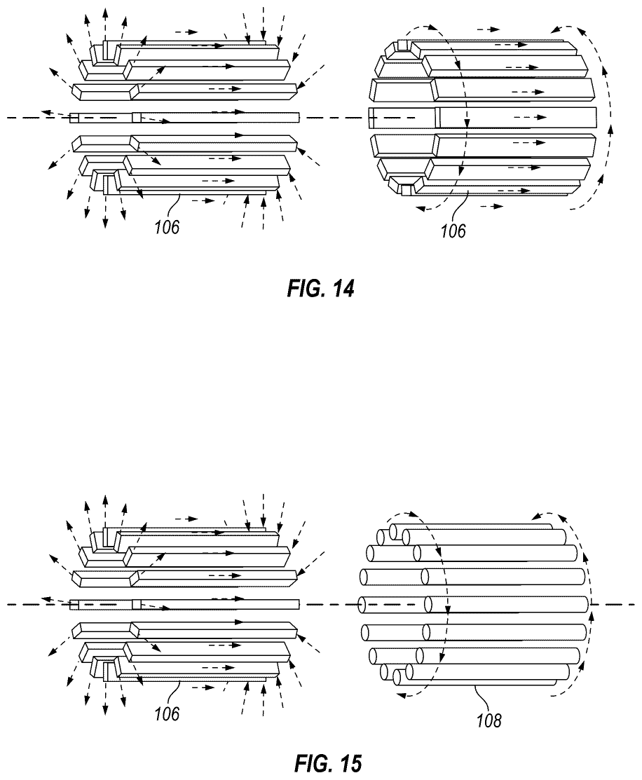

For example, FIG. 11 illustrates EM transmitter 106 and EM receiver 108 oriented in Z and R directions, respectively. FIG. 12 illustrates EM transmitter 106 and EM receiver 108 both oriented in a Z direction. FIG. 13 illustrates EM transmitter 106 and EM receiver 108 both oriented in a Phi direction. FIG. 14 illustrates EM transmitter 106 and EM receiver 108, oriented in an R and Phi direction, respectively. FIG. 15 illustrates EM transmitter 106 and EM receiver 108, oriented in a Phi and Z direction, respectively. As noted above and illustrated in FIGS. 11-15, EM transmitters 106 may be oriented in an axial, a radial, or an azimuthal direction. Likewise, EM receivers 108 may be oriented in an axial, a radial, or an azimuthal direction. Different orientations of EM transmitter 106 and/or EM receiver 108 may allow for different modes of eddy current excitation and sensing from downhole tubulars, such as casing string 116 (e.g., referring to FIG. 1). These different modes enable azimuthal sensitivity to different sides of the pipes. These configurations of EM transmitter 106 and EM receiver 108 may allow for electromagnetic measurements in block 902.

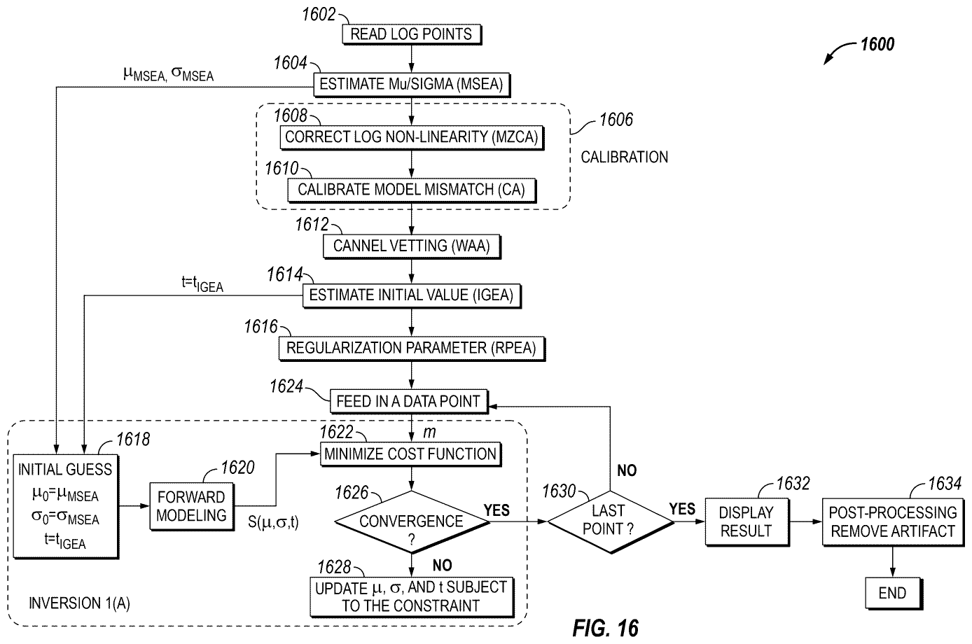

The electromagnetic measurements from block 902 may then be utilized in block 904 to estimate pipe parameters. The electromagnetic measurements may be utilized in a model-based inversion algorithm identified as workflow 1600 as illustrated in FIG. 16. The model-based inversion algorithm, described in workflow 1600, may be a radial one-dimensional or radial two-dimensional mathematical algorithm. This may allow for solving circumferential averaged pipe thickness and/or eccentricity ratios. Further, the model-based inversion algorithm, described in workflow 1600, may be two-dimensional or three-dimensional mathematical algorithm. This may allow for solving for a downhole tubular thickness azimuthal distribution (such as casing string 116), an eccentricity ratio, and/or an eccentricity angle.

Workflow 1600 may be utilized to estimate pipe parameters such as downhole tubular wall thickness, circumferential averaged metal loss, an azimuthal metal loss, an eccentricity ratio, an eccentricity angle, a downhole tubular ovality, a downhole tubular deformation, magnetic permeability, electrical conductivity, based at least in part on the electromagnetic measurements from block 902. It should be noted that workflow 1600 may be performed at least in part on information handling system 144 (e.g., referring to FIG. 1). In block 904, the individual estimation of pipe thickness necessitates the inversion of numerous unknown parameters, comprising electrical conductivity, magnetic permeability, individual wall thickness, and eccentricity. It should be noted that workflow 1600 may at least in part be performed on information handling system 144. Workflow 1600 may begin with block 1602. In block 1602, one or more measurements during a measurement operation may be taken by EM logging sub 104 utilizing the methods and systems described above. The one or more measurements may be utilized to form a wellbore log for every depth in wellbore 118. In block 1604, one or more measurements may be utilized to estimate Mu/Sigma (MESA). The estimation of the magnetic permeability (μ) and electrical conductivity (c) of the pipes involves minimizing the difference between measured and synthetic responses, with a focus on identifiable features such as collars or zone transitions. In calibration operation 1606, one or more calibration constants (W_{cal}) may be established to correct for differences between the logging tool properties and the synthetic model properties, comprising factors like signal level and coil turns. This linear calibration process is essential for the subsequent pointwise inversion of the wellbore log. Blocks 1608 and 1610 may be performed in calibration operation 1606.

In block 1608, which may be performed in block 906, referring back to FIG. 9, using the data from block 904, the wellbore log may be calibrated to correct for non-linearity. To tackle non-linearity in the log response, a multi-zone correction algorithm (MZCA) is employed. MZCA addresses non-linearity and improves accuracy, especially for detecting large defects on outer pipes. In block 1610, a calibration may be performed for model mismatch. Model mismatch calibration may comprise matching measurements taken by logging tool 100, which may be referred to as a logging tool response, at a section with known pipe parameters of downhole tubulars, such as casing string 116 (e.g., referring to FIG. 1), to a model response (i.e., a simulated response) of the same pipe parameters. The calibration section may comprise a calibration depth, where the calibration depth is defined as all pipes having known pipe parameters, such as a nominal thickness and/or eccentricity values. Further, there may be a plurality of calibration depths in which the nominal thicknesses and eccentricity values at each of the calibration depths may be different. After calibration, vetting may be performed.

In block 1612, channel vetting may be performed by utilizing an automatic channel weight assignment algorithm (WAA). The WAA has been devised to select data channels for inversion. WAA identifies and deactivates noisy channels by considering factors such as low correlation with other channels, high dynamic range, wide spatial spectra, and low average/standard deviation ratio. Additionally, it determines the ideal number of receivers based on the pipe configuration to ensure inversion stability without compromising vertical resolution.

In block 1614, initial values are estimated as an initial guess estimation (IGEA). The outcomes generated by this algorithm serve as a foundational reference for regularization parameter estimation (RPEA) in block 1616 to identify a regularization term and as initial approximations in the inversion process. A regularization term is incorporated into the cost function to restrict the solution to physically realistic outcomes. For example, pipe thicknesses may be constrained to a nominal value, which may allow for minimization to solve for an eccentricity ratio. The optimal regularization weights (Wₓ in Equation (6)) may be calculated by minimizing negative covariance, which helps alleviate unwanted coupling between pipe thicknesses stemming from the ill-posed nature of the inverse problem.

In block 1618, the estimates from block 1604 and the estimates from block 1614 may be recorded on information handling system 144 and then utilized in a forward model of block 1620. The forward model may be expressed as:

$$F ( x ) = \frac{1}{2 M} {‖ {W}_{m , a b s} \times [ abs \{ \frac{s ( x )}{{W}_{cal} m} \} - 1 ] ‖}^{2} + \frac{1}{2 M} {‖ {W}_{m , a n g l e} \times phase \{ \frac{s ( x )}{{W}_{cal} m} \} ‖}^{2} + {‖ {W}_{x} \times ( \frac{x}{{x}_{I G}} - 1 ) ‖}^{2} \qquad ( 6 )$$

The inversion process employs a cost function comprising three terms: magnitude misfit, phase misfit, and a regularization term to penalize non-physical solutions. An example of this cost function is provided below:

Different quantities in the cost function are defined as at least where x is a vector of N (unknown) model parameters expressed mathematically as:

$$x = [ {t}_{1} , … , {t}_{{N}_{P}} , {μ}_{1} , … , {μ}_{{N}_{P}} , ec {c}_{1 , 2} , … ] \qquad ( 7 )$$

Nₚ is the number of pipes; tᵢ denotes the thickness of pipe i, μᵢ denotes the magnetic permeability of pipe i, and ecc_{i,j} denotes the eccentricity of pipe i with respect to pipe j. Additionally, m is a vector of M complex-valued measurements at different receivers and frequencies, expressed mathematically as:

$$M = {N}_{r x} \times {N}_{f} \qquad ( 8 )$$

where Nᵣₓ is the number of receivers and N_{f} is number of frequencies. The variable s(x) is a vector of M forward modeling (synthetic) responses. W_{m,abs} and W_{m,angle} are variables for weight matrices for measurements magnitude and phase. In examples, M×M diagonal matrices may be used to assign different weights to different measurements based on the relative quality or importance of each measurement. Thus, W_{cal} is a M×M diagonal matrix of complex-valued calibration constants, Wₓ is a N×N diagonal matrix of regularization parameters, and x_{IG} is a vector of N initial guesses.

Data, such as measurements or known values, from block 1624 may be fed into the forward model from block 1620. In block 1622, the solution of the inverse problem (i.e., the forward model from block 1620) entails identifying model parameters that minimize the cost function in Equation (6). This may be achieved through an iterative, non-linear numerical optimization algorithm.

In block 1626, it is determined if a convergence is found through minimization of the cost function. If there is not a minimization, the variables from block 1618 may be updated in block 1628 and placed back into the forward model in block 1620. The process may be repeated until there is convergence in block 1626. Upon convergence in block 1626, in block 1630, it is determined if the last point for measurement data has been run through the forward model in block 1620. Specifically, if the last point is the last depth of measurement for measurement operations discussed above. If more data points may exist, then the data in block 1624 may be updated and the forward model in block 1620 may be updated with the data and in block 1622, the cost function minimization may be run again, according to methods and systems above. Referring back to block 1630, if the last point for measurements has been run through the forward model in block 1622, the results for all depths and measurements may be display in block 1632 using information handling system 144 (e.g., referring to FIG. 1). Additionally, post processing methods in block 1634 may be applied to the data to remove artifacts from the data, which may effectively end workflow 1600. Referring back to FIG. 9, the solutions in block 1634 are the estimated pipe parameters found in block 906.

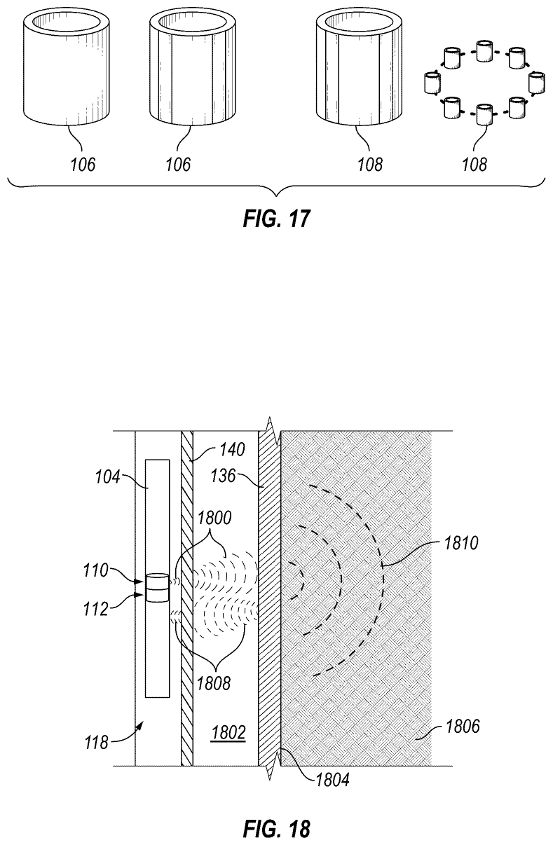

In block 908, acoustic measurements are taken. Acoustic measurements may be taken utilizing acoustic sub 104. In examples, acoustic sub 104 may comprise one or more acoustic transmitters 110 and/or one or more acoustic receivers 112. FIG. 17 illustrates examples of acoustic transmitter 110 and acoustic receiver 112. Acoustic transmitters 110 (as well as acoustic receivers 112) may be a monopole or comprise multipole sources (e.g., dipole, cross-dipole, quadrupole, hexapole, or higher order multi-pole transmitters). Additionally, one or more acoustic transmitters 110 (which may comprise segmented transmitters) may be combined to excite a mode corresponding to an irregular/arbitrary mode shape. For example, acoustic transmitter 110 may be cylindrical and/or segmented piezoelectric tube. Additionally, acoustic transmitter 110 may be a monopole, a dipole, a cross-dipole transmitter, a quadrupole, or a rotating transmitter of any mode, and/or a higher order transmitter. Acoustic receivers 112 may comprise a segmented piezoelectric tube, individual receiver, or azimuthal receiver array, which may produce azimuthal variation of bonding behind first casing 136. It should be noted that acoustic transmitter 110 and acoustic receiver 112 may be combined into a single element with the ability to both transmit acoustic waves and receive acoustic waves, which may be identified as a transceiver.

FIG. 18 illustrates acoustic sub 104 disposed in wellbore 118, wherein acoustic transmitter 110 may broadcast and/or transmit a shaped acoustic signal 1800 through pipe string 140, which may excite a fluid 1802 that may be disposed between pipe string 140 and casing 136. Shaped acoustic signal 1800 may be transmitted at 1 Hz to 100 MHz. It should be noted that fluid 1802 may comprise mud, formation fluid, and/or reservoir fluid disposed downhole for drilling operations. Additionally, fluid 1802 may be disposed within pipe string 140. Thus, fluid 1802 may be within pipe string 140 and be disposed between pipe string 140 and casing 136. Shaped acoustic signal 1800 may lose energy as it passes through pipe string 140, however, shaped acoustic signal 1800 may continue to resonance through fluid 1802 to casing 136. At casing 136, shaped acoustic signal 1800 may interact with boundary 1804 that is casing 136 and material 1806. Material 1806 may be cement, water, air, and/or any combination thereof. The interaction at boundary 1804 may cause result signal 1808 and dissipated signal 1810. Result signal 1808 may be reflected off boundary 1804 back to acoustic sub 104. In examples, result signal 1808 comprises reflections, refractions, and/or a resonance which is formed in late time.

With continued reference to FIG. 18, result signal 1808 may interact with pipe string 140, pass through pipe string 140, and be sense, recorded, and/or measured by EM receiver 112. Result signal 1808 may be between 1 to 100 kHz. Dissipated signal 1810 may continue to move through material 1806, which may continuously capture energy from dissipated signal 1810 until dissipated signal 1810 is extinguished. Result signal 1808 may be processed to further determine if material 1806 (i.e., cement, water, air, and/or the like) may be bonded to first casing 136.

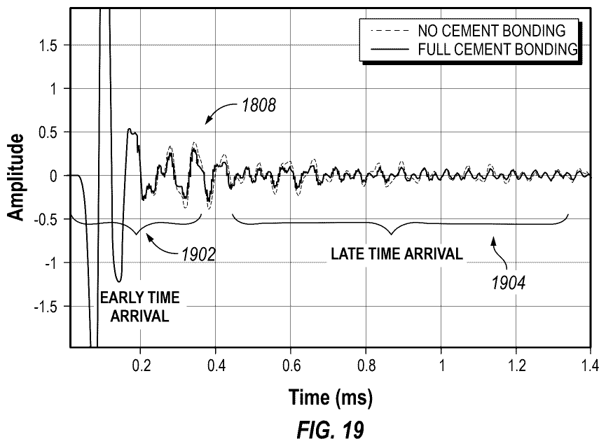

For example, FIG. 19 illustrates a graph of one or more result signals 1808, which was captured by acoustic receiver 112 (e.g., referring to FIG. 5). As illustrated, early time arrivals 1902 comprises acoustic energy, which may comprise reflections from pipe string 140, reflections from first casing 136 through pipe string 140, guided wave refractions from pipe string 140, guided-wave refractions from first casing 136 through pipe string 140 (e.g., referring to FIG. 18), Stoneley waves, tool waves, and/or the like. These waves may be categorized as non-resonance waves. After a certain time, certain waves propagate away from acoustic receiver 112 in the form of guided casing wave, guided tubing wave, tool wave, Stoneley wave and/or multiple reflections (e.g., not illustrated and represented by dissipated signal 1810). Hence in late time arrivals 1904, result signal 1808 is observed to have fixed frequency components and with decreasing amplitude over time. As such, late arrivals 1904 may comprise at least part of a resonance mode signal. Herein, resonance mode may be defined as the resonance of the pipe string 140 (e.g., referring to FIG. 1), pipe string 140, tool 100, and fluid 1802 (e.g., referring to FIG. 5).

The resonance mode signal may be categorized into one or any number of poles. For example, a monopole transmitter (e.g., referring to FIG. 17) may generate monopole resonance modes. With borehole asymmetry, a monopole transmitter may also generate other multiple resonance modes, such as dipole and quadrupole modes. A signal received by acoustic receiver 112 may be decomposed to monopole, dipole, unipole, quadrupole and higher order responses, or a response with any specific mode shape. Each resonance mode may comprise a unique frequency, mode shape, modal decay rate, and/or attenuation rate. Each multipole resonance mode may be identified by mode analysis. Mode analysis may be used to identify the frequency of a resonance frequency.

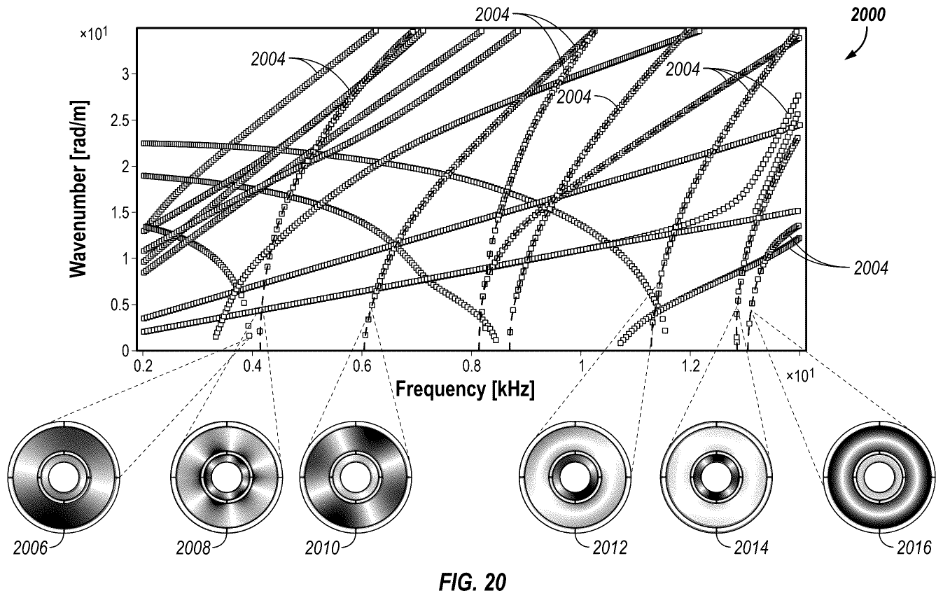

FIG. 20 illustrates a dispersion curve (wavenumber vs. frequency) generated from mode analysis simulation from at least part of a pipe string 140 and pipe string 140 (e.g., referring to FIG. 1) dispersion configuration 2000. Resonance mode signals 2004 for dispersion configuration 2000 may be identified by a curve approaching the x-axis (zero wavenumber) vertically due to the group velocity of a standing wave being zero. Each resonance mode signal 2004 represents a specific mode shape. The corresponding mode shape from each resonance mode signal 2004 may also be identified from mode analysis. Mode analysis may identify the nature of the mode and whether it is sensitive to cement bonding. The mode shape of a specific mode may be expressed as pressure level in the fluid 1802 (e.g., referring to FIG. 18) or the displacement/stress in the pipe string 140 and/or pipe string 140. Mode analysis may be enhanced with numerical simulation. For example, monopole resonance signal 2006, dipole resonance signal 2008, and quadrupole acoustic resonance signal 2010 resonance mode may be a first order radial direction acoustic resonance mode shapes. Second order dipole acoustic resonance signal 2012, second order quadrupole resonance signal 2014, and second order monopole acoustic resonance signal 2016 may depict a second order dipole acoustic resonance signal 2012. A resonance mode may be excited by an acoustic transmitter 110 (e.g., referring to FIG. 1) of the same mode at the corresponding resonance frequency. A resonance mode may be generated from mode conversion due to eccentricity, bonding condition, or other asymmetry.

A resonance mode may also be categorized by a dominant domain of vibration, such as inner annulus, outer annulus or both inner and outer annulus. For example, monopole resonance signal 2006, quadrupole acoustic resonance signal 2010, second order dipole acoustic resonance signal 2012, and second order monopole acoustic resonance signal 2016 may comprise energy in pipe string 140 and pipe string 140. The pressure in pipe string 140 may induce a displacement in the casing, forming leaky waves within the cement behind and/or within one or more tubulars of pipe string 140. Hence monopole resonance signal 2006, quadrupole acoustic resonance signal 2010, second order dipole acoustic resonance signal 2012, and second order monopole acoustic resonance signal 2016 may be particularly sensitive to cement bonding. In effect, higher tubing displacement indicates higher cement-sensitivity. Alternatively, mode analysis of casing displacement may be another indicator of the sensitivity of a mode to cement bonding. In examples, casing displacement shows the casing and tubing displacement under a particular resonance frequency. A higher casing displacement may indicate sensitivity to cement.

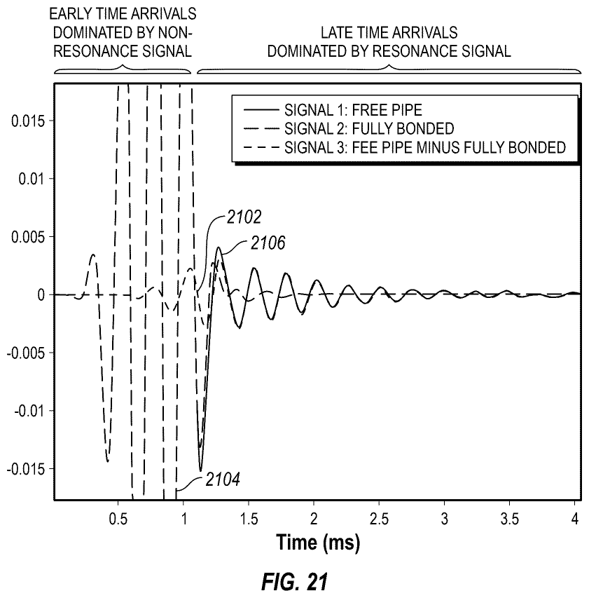

The early arriving non-resonance signal in time domain may not be very sensitive to cement bonding. Additionally, this phenomenon may be further explored in FIG. 21. FIG. 21 illustrates a time domain dipole signal for free pipe signal, fully bonded signal and free pipe signal with baseline signal removed where baseline signal is taken as the fully bonded signal. As shown in FIGS. 19 and 21, there is little difference between the free pipe signal and the fully bonded signal in the early time. Hence one way to extract cement-sensitive resonance signal is to take the late time response, filter to the frequency of the mode of interest, and calculate the amplitude.

Another way to remove early time arrivals 1902 (e.g., referring to FIG. 18) is by subtracting a baseline time-domain signal. Free pipe signal 2106 minus fully bonded signal 2102 may form baseline time-domain signal 2104 after baseline-removal. Free pipe signal 2106 minus fully bonded signal 2102 becomes baseline time-domain signal 2104. Baseline time-domain signal 2104 may be identified as the resonance signal with the non-resonance signal (reflections, guided waves, tool mode, etc.) removed. For baseline time-domain signal 2104, the amplitude may be computed from early time or from time zero. The measurements taken by acoustic measurement operations may be combined with EM measurements to update and increase the reliability of bonding logs.

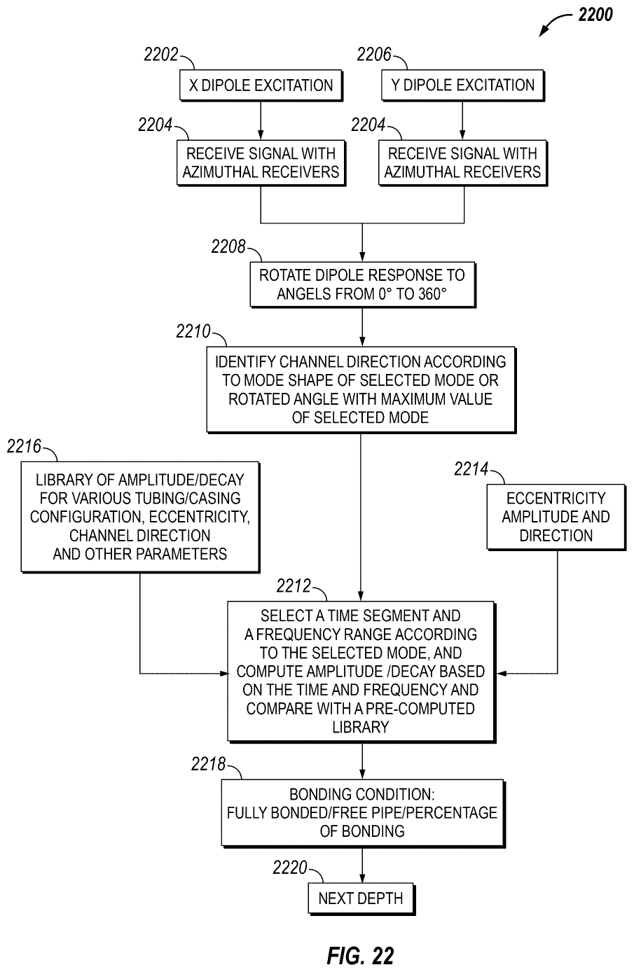

Referring back to FIG. 9, in block 910 a cement bond may be evaluated based at least in part on the data from block 908. FIG. 22 illustrates workflow 2200 that determines a bonding condition between material 1806 and casing 136, (e.g., referring to FIG. 18) using both EM and acoustic measurements. It should be noted that workflow 2200 may be at least in part performed on information handling system 144. Workflow 2200 may begin with block 2202 or block 2206. In other examples, block 2202 and block 2206 may be performed simultaneously. In block 2202 an X dipole excitation (i.e., an acoustic waveform in the X direction) may be transmitted from one or more acoustic transmitters 110 (e.g., referring to FIG. 18). In examples, X dipole excitation may transmit acoustic signals through logging fluid, tubulars, annulus between tubulars, comprising tubing and casings, depending on the frequencies and resonating modes of the acoustic signals. In block 2204, one or more result signals 1808 may be received and/or recorded by one or more acoustic receivers 112 (e.g., referring to FIG. 18). As noted above, in block 2206 a Y dipole excitation (i.e., an acoustic waveform in the Y direction) may be transmitted from one or more acoustic transmitters 110. In examples, Y dipole excitation, almost perpendicular to X dipole excitation, may transmit acoustic signals through logging fluid, tubulars, annulus between tubulars, comprising tubing and casings, depending on the frequencies and resonating modes of the acoustic signals. As noted above, in block 2204, one or more result signals 1808 may be received and/or recorded by one or more acoustic receivers 112. Further, one or more result signals 1808 created by both X dipole excitation in block 2202 and Y dipole excitation in block 2206 may be receiver and/or recorded by one or more acoustic receivers 110 simultaneously when block 2202 and block 2206 may be performed simultaneously. The responses received in block 2204 may be further analyzed by processing the data from the response with information handling system 144.

In block 2208, each dipole response received and/or recorded by acoustic receivers 112 may be rotated to angles from 0° to 360°. This rotation comprises the transformation of data from the original angles to the target angles by utilizing the orthogonality of X and Y dipole data. In block 2210, a channel direction according to mode shape of selected mode or rotated angle with maximum value of selected mode may be identified. While block 2210 is optional, it may be helpful to achieve the highest channel sensitivity. This may be performed by digitally transforming the X and Y dipole data, as described above in this disclosure. The information obtained in block 2210 may be utilized with additional measurements and data in block 2212.

Block 2212 is block 912 of FIG. 9 in which the data from blocks 910 and 906 are utilized to correct cement bond information. In block 2212, a time segment and a frequency range may be selected according to the selected mode. Additionally, amplitude and decay may be computed based at least in part on the time and frequency. In block 2214, eccentricity amplitude and direction, found from EM measurements taken and processed using processing algorithms such as pattern recognition and/or inversion. Amplitude and decay may be compared to a pre-computed library. The pre-computed library in block 2216 may comprise of amplitude and decay for various tubing/casing configurations, eccentricity, channel direction, and/or other parameters. Using the comparison, in block 2218, a bonding condition may be found that identifies if there is fully bonded pipe, free pipe, or a percentage of bonding between material 1806 and casing 136. This may be performed by identifying one or more acoustic attributes, from the one or more result signals 1808 (e.g., referring to FIG. 18), that identify a bonding condition, such as fully bonded pipe, free pipe, or a percentage of bonding between material 1806 and casing 136. It should be noted that one or more acoustic attributes may be insensitive to one or more pipe parameters. In such case, electromagnetic measurements may be performed to identify the one or more pipe parameters, as discussed above. By identifying the one or more pipe parameters, as discussed above, using electromagnetic measurements, the acoustic attributes, which were insensitive, may be corrected to conform to the one or more pipe parameters. In block 2220, workflow 2200 may be repeated for another depth in which measurements were made during the measurement operation. In other examples, acoustic transmitter 110 may rotate source to receive multiple firings at different azimuth.

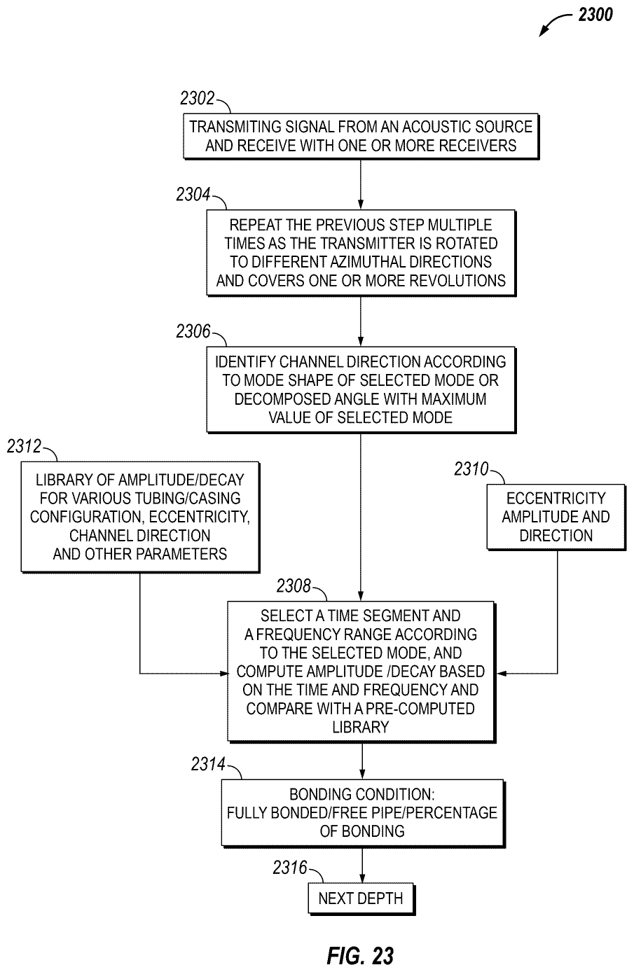

FIG. 23 illustrates a workflow 2300 that determines a bonding condition between material 1806 and casing 136 (e.g., referring to FIG. 18) using both EM and acoustic measurements that is an alternative to workflow 2200. It should be noted that workflow 2300 may be at least in part performed on information handling system 144 (e.g., referring to FIG. 1). Workflow 2300 may begin with block 2302. In block 2302 a signal is transmitted from one or more acoustic transmitters 110 (e.g., referring to FIG. 18). One or more result signals 1808 may be received and/or recorded by one or more acoustic receivers 112. The responses received in block 2302 may be further analyzed by processing the data from the response with information handling system 144.

In block 2304, block 2302 may be repeated multiple times for multiple measurements as acoustic transmitter 110 may be rotated to different azimuthal directions and cover one or more revolutions. In block 2306, a channel direction according to mode shape of selected mode or rotated angle with maximum value of selected mode may be identified. As noted above in workflow 2200, block 2306 may be optional, but it is helpful to achieve the highest channel sensitivity. This may be performed by digitally transforming the X and Y dipole data, as disclosed herein. The information obtained in block 2306 may be utilized with additional measurements and data in block 2308.

Block 2308 is block 912 of FIG. 9 in which the data from blocks 910 and 906 are utilized to correct cement bond information. In block 2308, a time segment and a frequency range may be selected according to the selected mode from block 2306. Additionally, amplitude and decay may be computed based at least in part on the time and frequency. In block 2310, tubular parameters, e.g., eccentricity amplitude and direction, found from EM measurements taken and processed using processing algorithms such as pattern recognition and/or inversion. Amplitude and decay may be compared to a pre-computed library. The pre-computed library in block 2312 may comprise of amplitude and decay for various tubing/casing configurations, eccentricity, channel direction, and/or other parameters. Using the comparison, in block 2314, a bonding condition may be found that identifies if there is fully bonded pipe, free pipe, or a percentage of bonding between material 1806 and casing 136. In block 2316, workflow 2300 may be repeated for another depth in which measurements were made during the measurement operation.

As described above, through tubing cement evaluation has been developed using monopole excited borehole resonance. Monopole mode changes with eccentricity and it is difficult to isolate in time and frequency domain. The dipole resonance mode has several advantages over the monopole counterpart. It may provide an alternative solution to complement the monopole result for an improved answer product. Though tubing cement evaluation may also be done by a pitch-catch rotary section with the casing related guided wave.

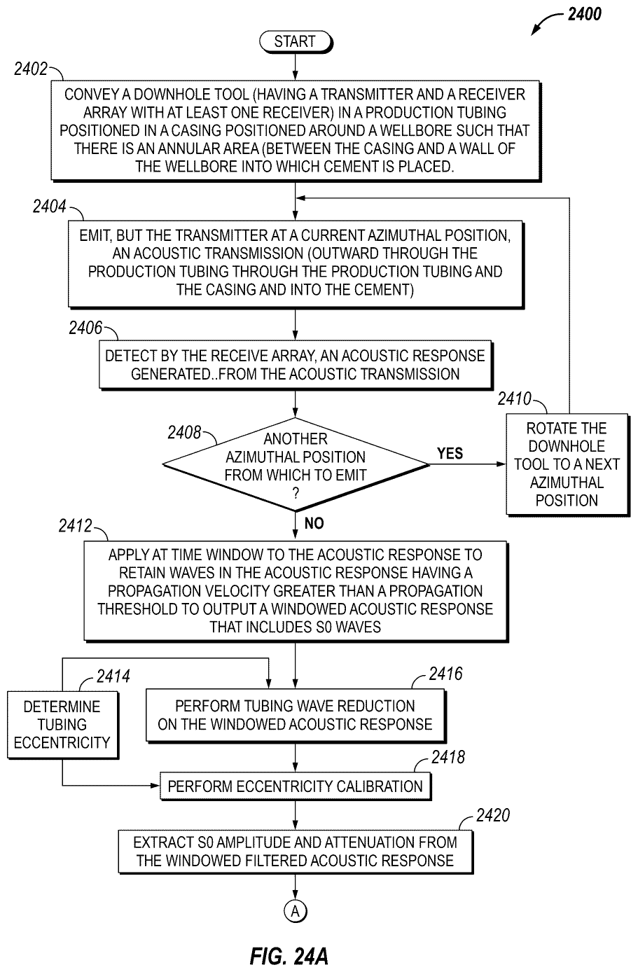

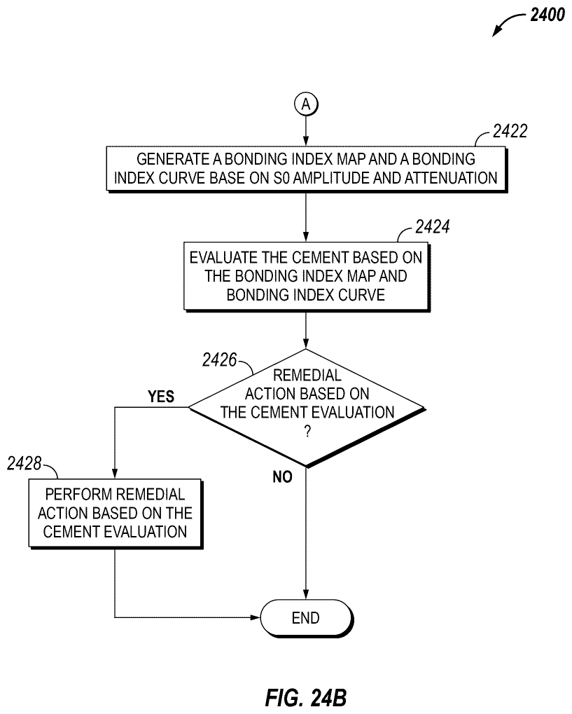

FIGS. 24A & 24B illustrate a workflow 2400 for performing acoustic measurements utilizing a pitch-catch method of measurements. FIGS. 24A & 24 B have operations that comprise a transition point A. It should be noted that workflow 2400 may be performed at least partially on information handling system 144 (e.g., referring to FIG. 1). However, such operations may be performed by other systems or components. For example, at least a part of workflow 2400 may be performed by information handling system 144 at a surface. In some embodiments, at least a part of workflow 2400 may be performed by information handling system 144 at the surface and/or downhole in wellbore 118 (e.g., referring to FIG. 1).

Workflow 2400 may begin with block 2402. At block 2402, logging tool 100 (e.g., referring to FIG. 1) may be conveyed in wellbore 118, as described above. At block 2404, an acoustic transmission is emitted, by acoustic transmitter 110 at a current azimuthal position (outward through the production tubing and the casing and into the cement). For example, with reference to FIG. 18, acoustic transmitter 110 may emit an acoustic transmission at a current azimuthal position in wellbore 118 outward toward and through pipe string 140 and casing 136 and into boundary 1804.

At block 2406, an acoustic response generated from the acoustic transmission is detected by the receiver array. For example, with reference to FIG. 18, one or more acoustic receivers 112 may detect result signals 1808 generated from the acoustic transmission that passes through pipe string 140, casing 136, and into material 1806.

At block 2408, a determination is made of whether there is another azimuthal position from which to emit an acoustic transmission. For example, measurement operations may be configured such that emission and detection may be performed at N number of different azimuthal positions. Accordingly, information handling system 144 may determine whether emission and detection has occurred at each of the N number of azimuthal positions. If there is another azimuthal position from which to emit an acoustic transmission, operations of workflow 2400 continue at block 2410. Otherwise, operations of workflow 2400 continue at block 2412.

At block 2410, logging tool 100 may be rotated to the next azimuthal position. For example, information handling system 144 may control logging tool 100 to rotate to a next azimuthal position from which to emit a next acoustic transmission. Operations of workflow 2400 return to block 2404.

At block 2412, a time window is applied to the acoustic response to retain waves in the acoustic response having a propagation velocity greater than a propagation threshold to output a windowed acoustic response that comprises S0 waves. For example, information handling system 144 may perform this operation. In particular, since the S0 wave is the fastest guided wave in a casing or tubing, S0 waves often become the first arrivals in the full waveform train after a period of propagation. If acoustic transmitter to acoustic receiver offset is appropriate, pure S0 waves may be obtained by applying a simple time window on the waveforms.

At block 2414, tubing eccentricity is determined. For example, logging tool 100 may be centered within pipe string 140. However, in some situations, pipe string 140 may be off center within casing 136. In such situations, the production tubing is considered eccentered in the casing. Consequently, in these situations, the tubing S0 waves may have the same arrival time in the azimuthal waveforms while the casing S0 waves do not have the same arrival time. In some embodiments, eccentricity of the tubing may be determined using the Third Interface Echo (TIE). The eccentricity may be defined in terms of its angle and phase. Additionally, eccentricity magnitude may be obtained from the EM induction tool using methods and systems described above. The determined tubing eccentricity may be input into operations at blocks 2416 and 2418.

At block 2416, tubing wave reduction is performed. For example, information handling system 144 (e.g., referring to FIG. 1) may perform this operation on the windowed acoustic response and based on the determined eccentricity. The casing S0 waves may be obtained by taking the difference of raw waveforms and predicting tubing signals. A filter may be used to extract the tubing S0 waves. Example filters for this extraction can comprise median filters, spatial filters (e.g., (FK) (frequency and wave number) filters), etc. The filtering may also be performed between receivers with different transmitter-receiver offsets. A wave separation operation may be performed to identify tubing S0 waves and casing S0 waves according to the difference of their propagation factor.

Block 2418 is block 912 of FIG. 9 in which the date from blocks 910 and 906 may be utilized to correct cement bond information. At block 2418, eccentricity calibrations may be performed. For example, information handling system 144 (e.g., referring to FIG. 1) may perform this operation. As shown by bidirectional arrows between block 2416 and 2418 and between blocks 2418 and 2420, the eccentricity calibration may be an iterative process to provide a more accurate value for the eccentricity for the current downhole operation. Thus, the eccentricity may be updated based on the operations at block 2416 and 2418.

At block 2420, S0 amplitude and attenuation are extracted from the windowed filtered acoustic response. For example, information handling system 144 (e.g., referring to FIG. 1) may extract the S0 amplitude and attenuation from the windowed filtered acoustic response. For example, the S0 amplitude can be determined based on determining an instantaneous amplitude of each wave and then taking an average of these instantaneous amplitudes. The attenuation may be determined based on a difference between a response at a first receiver and a response at a second receiver (with the receivers at two different axial positions relative to the transmitter). In other words, the attenuation can be determined based on a difference in two receivers having different transmitter-receiver offsets.

As illustrated in workflow 2400 of FIG. 24A, operations continue at transition point A which continue at transition point A of workflow 2400 on FIG. 24B. From transition point A of workflow 2400, operations continue at block 2422.

At block 2422, a bonding index map and/or bonding index curve are generated based on the S0 amplitude and attenuation. For example, information handling system 144 (e.g., referring to FIG. 1) may generate the bonding index map and/or bonding index curve. Additionally, in block 2424, evaluation of the cement based on the bonding index map and the bonding index curve is performed. For example, information handling system 144 (e.g., referring to FIG. 1) may perform this cement evaluation. For instance (as described above), the value of the bonding index may enable evaluation of the cement. If the bonding index value is 0, the cement is considered fully bonded. If the bonding index value is 1, this section of the wellbore may be considered free pipe with no cement. If the bonding index is greater than 0 but less than 1, the cement may be considered partially bonded having fluid channels-which may be considered a fault in the cement.

At block 2426, a determination is made of whether a remedial action is needed based on the cement bonding condition evaluation. For example, information handling system 144 (e.g., referring to FIG. 1) may make this determination. For instance, if the cement bonding condition evaluation identifies one or more fluid channels having a size greater than a threshold, the determination may be made that a remedial action is needed to correct these faults. If a remedial action is needed, operations of workflow 2400 continue at block 2428. Otherwise, operations of workflow 2400 are complete.

At block 2428, a remedial action based on the cement bonding condition evaluation is performed. For example, information handling system 144 (e.g., referring to FIG. 1) may initiate such an operation. For instance, information handling system 144 may initiate an operation to provide a remedial action to correct a fault (such as the cement bonding). An example of a remedial action can comprise different types of remedial cementing (such as squeeze cementing). Operations of workflow 2400 are complete.

Though tubing cement evaluation may also be done a combined/joint processing with the resonance and guide wave data, or in the results domain. All the abovementioned results might be susceptible to eccentricities, especially high eccentricity. As disclosed above, the eccentricity magnitude may be obtained from the EM induction tool, while the eccentricity direction may still rely on the data from the pitch-catch rotary section. Additional corrections from other pipe parameters to the cement bonding may be integrated.

Improvements from the methods and systems described above comprise correcting the environmental factors, e.g. tubular eccentricities, both the magnitudes and directions.

Statement 1: A method may comprise disposing a logging tool in a wellbore. The logging tool may comprise an electromagnetic (EM) sub and an acoustic sub. The method may further comprise transmitting an EM field from the EM sub into one or more tubulars to energize the one or more tubulars with the EM field thereby producing an eddy current that creates a secondary EM field in at least one or more of the tubulars and measuring the secondary EM field in the one or more tubulars with a EM receiver measuring the eddy current in the one or more tubulars with the EM receiver on at least one channel to obtain a plurality of EM measurements. The method may further comprise transmitting a shaped acoustic signal from the acoustic sub into one or more tubulars and formation, measuring a result signal with the acoustic sub to form one or more acoustic measurements, estimating one or more pipe parameters from the eddy current, and evaluating a cement bond based at least in part on the one or more pipe parameters and the one or more acoustic measurements.

Statement 2: The method of statement 1, wherein estimating the one or more pipe parameters is performed by a model-based inversion, which minimizes a cost function.

Statement 3: The method of statement 2, wherein the model-based inversion comprises calibrating a logging tool response to a model response at one or more calibration depths with known pipe parameters.

Statement 4: The method of statement 3, wherein the one or more calibration depths are used to calibrate the logging tool response and wherein the one or more calibration depths have different eccentricity values.

Statement 5: The method of statements 1 or 2, wherein the model-based inversion is a radial one-dimensional or a radial two-dimensional which solves for a circumferential averaged pipe thickness or an eccentricity ratio.

Statement 6: The method of any previous statements 1, 2, or 5, wherein the model-based inversion is a two-dimensional or a three-dimensional and solves for a downhole tubular thickness azimuthal distribution, an eccentricity ratio, or an eccentricity angle.

Statement 7: The method of any previous statements 1, 2, 5, or 6, wherein estimating pipe parameters comprises constraining pipe thicknesses to a nominal value and solving for an eccentricity ratio.

Statement 8: The method of any previous statements 1, 2, 5, 6, or 7, wherein the evaluation of the cement bond further comprises computing one or more acoustic attributes that vary with bonding conditions from one or more result signals.

Statement 9: The method of statement 8, wherein the one or more acoustic attributes may be insensitive to the one or more pipe parameters.

Statement 10: The method of claim 8, wherein the one or more acoustic attributes may be corrected by the one or more pipe parameters.

Statement 11: A system may comprise a logging tool. The logging tool may comprise an electromagnetic (EM) sub that transmits an EM field from an EM transmitter into one or more tubulars to energize the one or more tubulars with the EM field thereby producing an eddy current that creates a secondary EM field in at least one or more of the tubulars and measures the secondary EM field in the one or more tubulars with an EM receiver on at least one channel to obtain a plurality of EM measurements and an acoustic sub that transmits a shaped acoustic signal with at least one acoustic transmitter into at least one or more of the tubulars and a formation; wherein at least one acoustic receiver disposed on the acoustic sub measures a result signal to form one or more acoustic measurements. The system may further comprise an information handling system. The information handling system may be configured to estimate one or more pipe parameters from the eddy current and evaluate a cement bond based at least in part on the one or more pipe parameters and the one or more acoustic measurements.

Statement 12: The system of statement 11, wherein a magnitude of the secondary EM field is inversely proportional to an amount of metal at an inspection location of the one or more tubulars.

Statement 13: The system of statement 12, wherein the EM receiver is a coil or a Hall effect sensor.

Statement 14: The system of any previous statements 11 or 12, wherein the EM transmitter transmits an EM field formed from a continuous wave current at one or more frequencies and the EM receiver measures an amplitude and a phase or a real and an imaginary part of a voltage at the one or more frequencies of the secondary EM field.

Statement 15: The system of any previous statements 11, 12, or 14, wherein the EM transmitter transmits an EM field formed from a pulsed current and the EM receiver measures a decay response of a voltage at one or more time delays.

Statement 16: The system of any previous statements 11, 12, 14, or 15, wherein the EM sub comprises an array of EM transmitters and an array of EM receivers disposed axially or azimuthally.

Statement 17: The system of any previous statements 11, 12, or 14-17, wherein the EM transmitter is oriented in an axial, a radial, or an azimuthal direction.

Statement 18: The system of any previous statements 11, 12, or 14-17, wherein the EM receiver is oriented in an axial, a radial, or an azimuthal direction.

Statement 19: The system of any previous statements 11, 12, or 14-18, wherein the one or more pipe parameters comprise at least one of a downhole tubular wall thickness, a circumferential averaged metal loss, an azimuthal metal loss, an eccentricity ratio, an eccentricity angle, a downhole tubular ovality, or a downhole tubular deformation.

Statement 20: The system of any previous statements 11, 12, or 14-19, wherein the acoustic transmitter is a monopole, a dipole, or a high-order pole and the acoustic receiver is disposed as a sectorial or a ring.

Statement 21: The system of any previous statements 11, 12, or 14-20, wherein the acoustic transmitter is disposed on a rotary section of the acoustic sub.

The preceding description provides various examples of the systems and methods of use disclosed herein which may contain different method steps and alternative combinations of components. It should be understood that, although individual examples may be discussed herein, the present disclosure covers all combinations of the disclosed examples, comprising, the different component combinations, method step combinations, and properties of the system. It should be understood that the compositions and methods are described in terms of “comprising,” “containing,” or “comprising” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any comprised range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing a logging tool in a wellbore, wherein the logging tool comprises:
an electromagnetic (EM) sub; and
an acoustic sub;
transmitting an EM field from the EM sub into one or more tubulars to energize the one or more tubulars with the EM field thereby producing an eddy current that creates a secondary EM field in at least one or more of the tubulars;
measuring the secondary EM field in the one or more tubulars with an EM receiver measuring the eddy current in the one or more tubulars with the EM receiver on at least one channel to obtain a plurality of EM measurements;
transmitting a shaped acoustic signal from the acoustic sub into one or more tubulars and formation;
measuring a result signal with the acoustic sub to form one or more acoustic measurements;
estimating one or more pipe parameters from the eddy current; and
evaluating a cement bond based at least in part on the one or more pipe parameters and the one or more acoustic measurements.

2. The method of claim 1, wherein estimating the one or more pipe parameters is performed by a model-based inversion, which minimizes a cost function.

3. The method of claim 2, wherein the model-based inversion comprises calibrating a logging tool response to a model response at one or more calibration depths with known pipe parameters.

4. The method of claim 3, wherein the one or more calibration depths are used to calibrate the logging tool response and wherein the one or more calibration depths have different eccentricity values.

5. The method of claim 2, wherein the model-based inversion is a radial one-dimensional or a radial two-dimensional which solves for a circumferential averaged pipe thickness or an eccentricity ratio.

6. The method of claim 2, wherein the model-based inversion is a two-dimensional or a three-dimensional and solves for a downhole tubular thickness azimuthal distribution, an eccentricity ratio, or an eccentricity angle.

7. The method of claim 2, wherein estimating pipe parameters comprises constraining pipe thicknesses to a nominal value and solving for an eccentricity ratio.

8. The method of claim 1, wherein the evaluating of the cement bond further comprises computing one or more acoustic attributes that vary with bonding conditions from one or more result signals.

9. The method of claim 8, wherein the one or more acoustic attributes may be insensitive to the one or more pipe parameters.

10. The method of claim 8, wherein the one or more acoustic attributes may be corrected by the one or more pipe parameters.

11. A system comprising:
a logging tool comprising:
an electromagnetic (EM) sub that transmits an EM field from an EM transmitter into one or more tubulars to energize the one or more tubulars with the EM field thereby producing an eddy current that creates a secondary EM field in at least one or more of the tubulars and measures the secondary EM field in the one or more tubulars with an EM receiver on at least one channel to obtain a plurality of EM measurements; and
an acoustic sub that transmits a shaped acoustic signal with at least one acoustic transmitter into at least one or more of the tubulars and a formation; wherein at least one acoustic receiver disposed on the acoustic sub measures a result signal to form one or more acoustic measurements; and
an information handling system configured to:
estimate one or more pipe parameters from the eddy current; and
evaluate a cement bond based at least in part on the one or more pipe parameters and the one or more acoustic measurements.

12. The system of claim 11, wherein a magnitude of the secondary EM field is inversely proportional to an amount of metal at an inspection location of the one or more tubulars.

13. The system of claim 12, wherein the EM receiver is a coil or a Hall effect sensor.

14. The system of claim 11, wherein the EM transmitter transmits an EM field formed from a continuous wave current at one or more frequencies and the EM receiver measures an amplitude and a phase or a real and an imaginary part of a voltage at the one or more frequencies of the secondary EM field.

15. The system of claim 11, wherein the EM transmitter transmits an EM field formed from a pulsed current and the EM receiver measures a decay response of a voltage at one or more time delays.

16. The system of claim 11, wherein the EM sub comprises an array of EM transmitters and an array of EM receivers disposed axially or azimuthally.

17. The system of claim 11, wherein the EM transmitter is oriented in an axial, a radial, or an azimuthal direction.

18. The system of claim 11, wherein the EM receiver is oriented in an axial, a radial, or an azimuthal direction.

19. The system of claim 11, wherein the one or more pipe parameters comprise at least one of a downhole tubular wall thickness, a circumferential averaged metal loss, an azimuthal metal loss, an eccentricity ratio, an eccentricity angle, a downhole tubular ovality, or a downhole tubular deformation.

20. The system of claim 11, wherein the acoustic transmitter is a monopole, a dipole, or a high-order pole and the acoustic receiver is disposed as a sectorial or a ring.

21. The system of claim 11, wherein the acoustic transmitter is disposed on a rotary section of the acoustic sub.
